(19) United States
(12) Patent Application Publication
(10) Pub. No.: US 2003/0059526 A1
(43) Pub. Date: Mar. 27, 2003

(54) Apparatus and method for the design and manufacture of patterned multilayer thin films and devices on fibrous or ribbon-like substrates

(76) Inventors: Martin H. Benson, Littleton, CO (US); Bernd J. Neudecker, Littleton, CO (US)

Correspondence Address: MCKENNA & CUNEO, LLP, 1900 K Street, NW, Washington, DC, 20006, US

(21) Appl. No.: 10/109,991

(22) Filed: Apr. 1, 2002

Related U.S. Application Data
(60) Provisional application No. 60/318,320, filed on Sep. 12, 2001.

(51) Int. Cl. B05D 5/12; B05D 7/02; B05D 7/06; B05D 7/14; B05D 7/24

(52) U.S. Cl. 427/121; 427/215; 427/216; 427/222; 29/623.5

(57) ABSTRACT

The present invention relates to patterned thin film electrochemical devices such as batteries on fibrous or ribbon-like substrates, as well as the design and manufacture of the same, for utilization in electrochemical cells, electronic devices, optical devices, synthetic multi-functional materials, and superconducting materials, as well as fiber reinforced composite material applications.

This invention may have been made with Government support under Contract No. N00014-00-C-0479 awarded by the Office of Naval Research. The Government may have certain rights in this invention.

### CROSS REFERENCE TO RELATED APPLICATIONS

The present application is related to and claims the benefit of, under 35 U.S.C. §119(e), U.S. Provisional Patent Application Serial No. 60/318,320, filed Sep. 12 2001, which is expressly incorporated fully herein by reference.

### BACKGROUND OF THE INVENTION

1. Field of the Invention

The present invention relates to patterned thin film electrochemical devices such as batteries on fibrous or ribbon-like substrates, as well as the design and manufacture of the same, for utilization in electrochemical cells, electronic devices, optical devices, synthetic multi-functional materials, and superconducting materials, as well as fiber reinforced composite material applications.

2. Description of the Related Art

Government and commercial entities often seek materials to meet limited space requirements for military and industrial applications. These requirements apply to devices such as power sources and multilayer materials. These devices typically may not easily meet these requirements because of limitations on their size, shape, and method of deposition. The present invention relates, for example, to creating multilayer materials by means of shadow masking a vacuum coating process on a fibrous substrate. The technology relates to two general categories: shadow masking of multilayer and multifunctional thin film coatings and vacuum coating of fibrous monofilament substrates.

A technique that has been widely used in the vacuum thin film industry to selectively deposit sequential or multilayer thin films in specific patterns is to apply a physical constraint to the vapor or plasma to prevent the vapor or plasma from reaching areas not targeted for deposition. The types of masks generally used include fabricated metal, glass, and ceramics, as well as photoresist patterned masking. The primary applications of these technologies have been restricted to planar substrate geometries. Examples of thin film product areas utilizing physical shadow masks include thin film batteries, electronic integrated microcircuits, circuit boards, diode arrays, and electroluminescent and semiconductor devices. Examples of these products may be found, for example, in U.S. Pat. Nos. 4,952,420; 6,214,631; 4,915,057; and in international patent or patent application WO 9930336 and German Patent No. DE 19850424.

Additionally, sequential shadow masking to produce patterned multilayer thin films has been explored. For example, in thin film battery designs, metal templates or shadow masks have been used to control the deposition of battery films in specific geometries to perform specific functions. Some of these functions include cathode-to-anode pairing, electrolyte separation, and current collector masking. These examples of planar configuration shadow masking may be seen, for example, in U.S. Pat. Nos. 6,218,049; 5,567,210; 5,338,625; 6,168,884; 5,445,906; and in international patent or patent application WO 9847196. Additionally, some examples of shadow masking on fiber substrates include European Patent No. EP 1030197 and U.S. Pat. No. 5,308,656.

Examples of photoresist masking for patterning vacuum deposited thin films may be seen, for example, in U.S. Pat. Nos. 6,093,973; 6,063,547; 5,641,612; 6,066,361; and 5,273,622; and in international patents or patent applications GB 2320135 and EP 1100120.

Vacuum thin film coatings have been used in, for example, fiber-reinforced composite materials, superconducting fibers and wires, as well as optical fiber applications. Largely, research in vacuum coated fibers has been confined to continuous substrate deposition. Some examples of continuous fiber coating apparatuses are U.S. Pat. Nos. 5,518,597; 5,178,743; 4,530,750; 5,273,622; 4,863,576; and 5,228,963; and international patents or patent applications WO 0056949; RU 2121464; and EP 0455408. Some examples of composite material fiber coating include U.S. Pat. Nos. 5,426,000; 5,378,500; 5,354,615; and international patents or patent applications EP 0423946, and GB 2279667. Some examples of optical fiber coating include U.S. Pat. Nos. 5,717,808; 4,726,319; 5,320,659; 5,346,520; and European Patent No. EP 0419882. Some examples of superconducting wire and fiber coatings include U.S. Pat. Nos. 6,154,599; 5,140,004; 5,079,218; and European Patent No. EP 290127.

### SUMMARY OF THE INVENTION

The present invention attempts to solve the limitations in the art, as described above, and to provide an apparatus and method for the design and manufacture of patterned multilayer thin films and devices.

The present invention relates, for example, to patterned thin film electrochemical devices such as batteries on fibrous or ribbon-like substrates, as well as the design and manufacture of the same, for utilization in electrochemical cells, electronic devices, optical devices, synthetic multi-functional materials, and superconducting materials, as well as fiber reinforced composite material applications.

In government and commercial industry research, a need exists for alternative geometry functional and multifunctional materials. These materials are sought as solutions for device physical space requirement reductions in, for example, military and industrial applications. In particular, these multilayer thin films and devices may be manufactured by vacuum depositing multilayer thin films on fibrous, ribbon-like, and strip-like substrates.

In a preferred embodiment, the present invention may relate to a method of depositing a patterned thin film on a fibrous or ribbon-like substrate by providing, for example, a fibrous or ribbon-like substrate, providing a tubular member with an interior diameter, positioning the substrate within the diameter of the tubular member, and depositing thin film material on the substrate. In a specific embodiment, the substrate may be rotated when thin film material is deposited.

In a further embodiment, the present invention may relate to an apparatus for use in patterning thin films on one or more fibrous or ribbon-like substrates. In a preferred embodiment, the apparatus may include, without limitation, one or more tubular members each having an interior diameter and means for positioning the fibrous or ribbon-like substrates. The means for positioning the fibrous or ribbon-like substrates may include, but is not limited to, means for rotating the substrates, means for co-axially moving the substrates, means for constraining the co-axial movement of the substrates, and/or means for providing tension in the substrates.

In a further embodiment, the present invention may relate to a method of depositing patterned thin films on a fibrous or ribbon-like substrate by providing the substrate, providing a plurality of deposition chambers, providing a means for masking the substrate, moving the substrate through each deposition chamber, and depositing thin film material in each deposition chamber. In a specific embodiment, the substrate may be rotated when the thin film material is deposited. In a specific embodiment, the method may further include interrupting the movement of the substrate. In a preferred embodiment, the time period when the movement of the substrate is interrupted may overlap with the time period when thin film material is deposited.

In a further embodiment, the present invention may relate to an apparatus for use in patterning thin films on a fibrous or ribbon-like substrate. In a preferred embodiment, the apparatus may include means for positioning the substrate, a plurality of deposition chambers, means for depositing thin film material on the substrate, and means for masking the substrate. In a specific embodiment, the means for positioning the substrate may include, but is not limited to, means for rotating the substrate. In a specific embodiment, each of the deposition chambers may include means for pressure control. In a specific embodiment, buffer chambers may be disposed between pairs of deposition chambers.

In a specific embodiment, the means for masking the substrate may further include means for remotely controlling the masking of the substrate. In a preferred embodiment, the means for masking the substrate may include a tubular member that has an interior diameter. The interior diameter may include, but is not limited to, a round shape, a round shape with a conical counterbore, a square shape, and a machined slot. The machined slot may include either one or two pieces. In a preferred embodiment, a round-shaped interior diameter may be between about 0.001 inches and about 0.100 inches greater than the diameter of the substrate. In a preferred embodiment, the interior diameter of a machined slot may be between about 0.001 inches and about 0.100 inches greater than the diameter of the substrate.

In a specific embodiment, the means for masking a substrate in the present invention may be, without limitation, linear, incremental, and/or bi-directional. In a specific embodiment, an incremental means for masking a substrate may be indexed.

It is an object of the present invention to provide a non-contact method of patterning thin film multilayer depositions on fibrous and ribbon-like substrates.

It is a further object of the present invention to provide a method of producing multilayer thin film functional patterns on fibrous or ribbon-like substrates in a single pass.

It is also an object of the present invention to provide a method of depositing thin film functional patterns on fibrous or ribbon-like substrates with reduced need for venting deposition chambers to the atmosphere. It is a further object of the present invention to provide a method of depositing thin film functional patterns on fibrous or ribbon-like substrates without a need for venting deposition chambers to the atmosphere.

It is an object of the present invention to provide a method for the tailorable production of thin film functional patterns on fibrous or ribbon-like substrates.

It is an object of the present invention to provide a selective and sequential multilayer thin film deposition patterning apparatus.

It is an object of the present invention to provide a selective and sequential multilayer thin film deposition patterning apparatus having a shadow masking apparatus wherein the masking aperture is a round or square hole.

It is an object of the present invention to provide a selective and sequential multilayer thin film deposition patterning apparatus having a shadow masking apparatus wherein the masking aperture is a round hole with a conical counterbore.

It is an object of the present invention to provide a selective and sequential multilayer thin film deposition patterning apparatus having a shadow masking apparatus wherein the masking aperture is a one or two piece machined component slot.

It is an object of the present invention to provide a selective and sequential multilayer thin film deposition patterning apparatus having a shadow masking apparatus wherein the masking aperture is a circular aperture between 0.001 and 0.1 inches larger than the substrate diameter.

It is an object of the present invention to provide a selective and sequential multilayer thin film deposition patterning apparatus having a shadow masking apparatus wherein the masking aperture is a slot aperture having side lengths and widths between 0.001 and 0.1 inches greater than the length and widths of the substrate sides.

It is an object of the present invention to provide a selective and sequential multilayer thin film deposition patterning apparatus having a shadow masking apparatus that permits linear incremental, non-contact, bi-directional, indexing motion.

It is an object of the present invention to provide a selective and sequential multilayer thin film deposition patterning apparatus that incorporates rotation of fibrous, ribbon-like, and strip-like substrates and shadow masking apparatus, to enhance coating uniformity in plasma and vapor processing.

It is an object of the present invention to provide a method for selective and sequential multilayer thin film deposition patterning on a substrate that is a cylindrical fiber, monofilament, wire, rod, ribbon or strip; for example, glass, sapphire, ceramic, polymer, metal, metal alloy, carbon, semiconductor, or shape memory alloy.

It is an object of the present invention to provide a method for selective and sequential multilayer thin film deposition patterning on a substrate that is a cylindrical fiber, monofilament, wire, rod, ribbon or strip, wherein the diameter or width of the substrate is between approximately 1 micron and approximately 0.25 inches.

It is an object of the present invention to provide a method for selective and sequential multilayer thin film deposition patterning on a substrate that is a square or rectangular thin strip of material; for example, glass, sapphire, ceramic, silicon, polymer, metal, or metal alloy.

It is an object of the present invention to provide a method for selective and sequential multilayer thin film deposition patterning on a substrate that is a square or rectangular thin strip of material, wherein the sides of the substrate have length or width is between approximately 1 micron and approximately 5.0 inches.

It is an object of the present invention to provide a method for selective and sequential multilayer thin film deposition patterning on a substrate wherein the pattern is a lithium, buried lithium, lithium-ion, buried lithium-ion, lithium-free, or buried lithium-free solid state battery.

It is an object of the present invention to provide a method for selective and sequential multilayer thin film deposition patterning on a substrate wherein the pattern is a copperindium-gallium-selenide (CIGS) photovoltaic cell.

It is an object of the present invention to provide a method for selective and sequential multilayer thin film deposition patterning on a substrate wherein the pattern is a microelectronic multiple interconnect device.

It is an object of the present invention to provide a method for selective and sequential multilayer thin film deposition patterning on a substrate wherein the pattern is functional, and the substrate is fibrous, ribbon-like, or strip-like.

It is an object of the present invention to provide a method for selective and sequential multilayer thin film deposition patterning on a substrate wherein the deposition produces a plurality of functional patterns with the aid of indexed substrate positioning.

Thin film functional patterns, as used herein, may include thin film devices such as batteries and photovoltaic cells, and also micro-electric circuits. Other functional patterns will be apparent to one skilled in the art, thus the term “functional patterns” is not meant to be limited to the examples given.

It is understood that both the foregoing general description and the following detailed description are exemplary and explanatory only and are not restrictive of the invention as claimed. The invention is described in terms of thin film electrochemical devices on fibrous or ribbon-like substrates; however, one skilled in the art will recognize other uses for the invention. For example, the invention may be used in the art of pyrotechnics and explosives by, for example, selecting a substrate that comprises a fuse. In this embodiment, the subsequently applied layers would not usually be applied by a plasma spray, and may be applied, for example, in a spray of an aqueous solution or tincture. Similarly, in the art of confection, an edible or non-poisonous (for example, wood or plastic) substrate may be used. In this embodiment, for example, superheated or similarly vaporized or atomized layers of confection (comprising, for example, nougat, caramel, or sugar) may be sprayed or otherwise deposited onto the substrate by means of the method or apparatus of the present invention. The accompanying drawings illustrating an embodiment of the invention and together with the description serve to explain the principles of the invention.

### BRIEF DESCRIPTION OF THE DRAWINGS

FIG. 1 is a perspective view diagram of a preferred embodiment of the present invention.

FIG. 2 is a partial cut-away diagram of a preferred embodiment of the present invention.

FIG. 3 is an axial view diagram of an example of a tubular member having a plurality of interior diameters.

FIG. 4a is a look-through diagram of an example of a tubular member and means for indexing with the tubular members in a “fully contracted” position.

FIG. 4b is a look-through diagram of an example of a tubular member and means for indexing with the tubular members in a “fully extended” position.

FIG. 5 is a flow diagram of a preferred embodiment of a method of the present invention.

FIG. 6 is a length-wise cutaway diagram of a copper-indium-gallium-selenide photovoltaic device configuration.

FIG. 7 is a length-wise cutaway diagram of a lithium-free battery configuration.

FIG. 8 is a length-wise cutaway diagram of a buried lithium-free battery configuration.

FIG. 9 is a length-wise cutaway diagram of a lithium-ion battery configuration.

FIG. 10 is a stylized depiction of the operation of a discrete deposition indexing method.

FIG. 11 is a perspective view diagram of an embodiment of the present invention employing a plurality of shadow masks.

FIG. 12 is a partial perspective view diagram of an embodiment of the present invention employing a two-piece, slot-shaped inner diameter or aperture.

FIG. 13 is a stylized look-through depiction of an embodiment of the present invention wherein the shadow mask is a non-tubular member.

### DETAILED DESCRIPTION OF THE INVENTION

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a layer” is a reference to one or more layers and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Additionally, except where the context clearly dictates otherwise, language that may be construed to suggest approximation should be understood in that sense. The invention is described in terms of thin film deposition on fibrous or ribbon-like substrates; however, one of ordinary skill in the art will recognize other applications for this invention including, for example, applications in confectionery sciences and pyrotechnics.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. All references cited herein are incorporated by reference herein in their entirety.

Definitions

For convenience, the meaning of certain terms and phrases employed in the specification, examples, and appended claims are provided below. The definitions are not meant to be limiting in nature and serve to provide a clearer understanding of certain aspects of the present invention.

The terms “woof” and “warp” refer to crosswise threads in weaving. For example, a plurality of woof threads are woven in one direction perpendicular to a plurality of warp threads to create a woven fabric.

All shapes referred to herein are to be understood as approximate. Thus, for example, a round shape is intended to encompass both completely as well as substantially or approximately round shapes.

Reference will now be made in detail to implementations of the present invention as illustrated in the accompanying drawings. Whenever possible, the same reference numbers will be used throughout the drawings and the following description to refer to the same or like parts.

A method is disclosed that facilitates deposition of multiple and multi-functional vacuum thin films sequentially and selectively on cylindrical and fibrous, ribbon-like, or strip-like substrates. The design of the present invention may be exemplified by an embodiment in which a thin film battery is deposited on a substrate. The shape of the patterns on the substrate may be controlled by means of a shadow mask. This substrate may also perform a secondary purpose; for example, the substrate may comprise an optical fiber. The invention may produce thin film devices that may be used in a wide variety of applications.

Moreover, the methods of deposition disclosed herein may permit the deposition of thin film devices on substrates which are not required to meet strict rigidity requirements. The present invention discloses a method that permits the deposition of, for example, selectively and/or systematically patterned thin film devices, which may be multilayered. Certain embodiments of the present invention include synthetic multi-functional materials such as thin film batteries on such substrates as optical fiber, super-conducting or shape memory substrates. These resultant multifunctional materials may have a wide array of uses including, for example, battery-amplified waveguides/optical fibers, power-generating fabrics, micro-airborne vehicles, and firearms.

One embodiment of the present invention, for example, overcomes the problems of planar geometric requirements by permitting thin film functional patterns to be deposited on fibrous substrates. Additionally, permitting thin film functional patterns to be deposited on fibrous substrates overcomes, for example, problems of reinforcing composite materials incorporating electrical and/or electrochemical cell function. Moreover, permitting thin film functional patterns to be deposited on fibrous substrates overcomes, for example, problems of device performance because it allows an increased amount of surface area to be available. An embodiment of the present invention, for example, overcomes the problem of barriers to innovative materials development by providing, by means of vacuum deposited thin films on fibrous, ribbon-like, or strip-like substrates, for the fabrication of electrical devices, optical devices, electrochemical devices such as solid-state batteries and photovoltaic cells, superconducting devices, synthetic multi-functional materials, as well as fiber reinforced composite material applications.

One embodiment of the present invention, for example, overcomes the problem of providing contacts in multilayer electrical devices deposited on fibrous or ribbon-like substrate through a method of patterned deposition that allows selective deposition thereby leaving some portions of underlying layers in a multilayer pattern exposed.

Another embodiment of the apparatus of the present invention comprises a means of shadow masking a substrate and a means for positioning a substrate. This embodiment may also comprise a means for moving a substrate. The means of shadow masking may comprise a sleeve or tubular member having an interior and exterior diameter. Thus, the means for shadow masking may be referred to as a tubular member. The means for shadow masking may also be viewed as a barrier having an aperture or orifice. In such a situation, the barrier corresponds to the tubular member, and the aperture is an opening or hole in the barrier.

This size and shape of the interior diameter (or aperture) of this member may be selected to roughly match the shape of a cross-section of a chosen substrate. For example, the shape may be round, square, rectangular or elliptical. While these shapes are examples, any shape including irregular shapes and dynamic shapes are permitted.

Examples of dynamic shapes of a cross-section of a substrate may include changes in shape over time, due to the deposition process, or due to temperature, pressure, or tension changes, as well as changes (i.e., differences) in the shape of a substrate's cross-section at different selected points along the length of the substrate.

By rough match, it is intended that the size and shape are not required to exactly or precisely equal the size and shape of the relevant substrate cross-section; however, a close match, for instance, in the example of a circular substrate cross-section, the interior diameter being between approximately 0.001 and approximately 0.1 inches larger than the diameter of the substrate, may be particularly advantageous. In another example, a substrate may have a rectangular shape with width and length. In this example, it may be particularly advantageous to select an interior diameter which has a width and length (for example, a slot shaped aperture) between approximately 0.001 and approximately 0.1 inches greater than the corresponding width and length of the substrate cross-section.

Although closer matches may provide better masking, they may also risk damage to the substrate or to the deposited films. More lenient matches may prevent contact between the interior diameter and the substrate, and may provide shadow masking of a lesser quality. Thus, the degree of closeness in matching the interior diameter is not stringent, and may be selected outside of the preferred limits, if desired. In particular, it may be desirable to select a tubular member that may be adjusted to fit and provide a seal on the substrate. This may be advantageous if the method of deposition is selected to be, for example, chemical bath deposition. Nevertheless, this may be neither a preferred fit for the tubular member nor a preferred method of deposition.

It is preferred that the means of masking comprise two or more tubular members separated by a distance. Additionally, if a plurality of tubular members mask the same substrate, it is generally preferable that the interior diameters of these members be roughly coaxial. This may allow a flexible substrate to be coated in an unflexed position, which may provide for a greater range of flexibility after deposition. In situations in which the substrate has an unflexed shape that differs from a straight line, for example, a substrate that is arc-shaped unflexed, a plurality of tubular members may preferably be placed to allow the substrate to remain unflexed. In other situations, tension or compression forces in the substrate may permit the use of coaxially aligned tubular members, which may be preferable in situations in which the shape of the substrate is readily deformable, such as, for example, where the substrate is an optical fiber.

When a pair of coaxial tubular members is used, the gap defined by the separation of the tubular members may be the deposition area. In other situations, the deposition area may be defined by the area traversed by the substrate between any two tubular members. In a situation in which only one tubular member is used, the deposition area may be the area approaching the tubular member.

The means for shadow masking may also comprise means for changing the size of the deposition area. This may be accomplished, for example, by producing relative motion of the shadow mask. For instance, a tubular member may be moved relative to the substrate or to another tubular member. In a preferred embodiment, the relative motion is accomplished by moving each tubular member while keeping the substrate in a fixed location; however, one may move, for example, one tubular member and the substrate while leaving the other tubular member in a fixed location.

The motion of the tubular members may be accomplished, for example, by providing an index to which the members may be aligned. This index may be continuous or discrete. Moreover, the index may be a mechanical index, as in the preferred embodiment of the present invention, or an electronic, optical, or hybrid index.

A mechanical indexing system may be implemented, for example, by slideably attaching the tubular member to an indexing member. The indexing member may be provided, for example, with notches and the tubular member may be provided with a ridge. In this notch-based indexing scheme, a position in the index may be achieved by sliding the tubular member so as to align the ridge in the tubular member with the notch in the indexing member. This same technique may be performed by providing notches in the tubular member and a ridge in the indexing member. The ridge may also be replaced, for example, by a removable member, such as, for example, a screw. The notches may be replaced, for example, by holes.

An example of an electrical index may include the use of an index member slideably connected to the tubular member. The relative position of the tubular member to the index member may be controlled, for example, by an electric motor. This position may be measured, for example, by incorporating optical sensors (in the case of a hybrid system) to observe the relative position, or the position may be deduced by combining information regarding the last relative movement of the tubular member with information regarding its previous position. This calculated positioning technique may be realized particularly well by means of a digitally controlled motor, such as, for example, a stepper motor.

Finally, an optical indexing scheme may be accomplished, for example, by slideably attaching the tubular member to an indexing member. This indexing member may be provided with, for example, marks indicating desired positions. The tubular member may then be relatively positioned so as to align with the marks.

Methods of indexing are numerous and those explained herein are exemplary only. Any indexing means, discrete or continuous, is acceptable for use in the present invention; however, means that provide a high degree of precision may provide particular advantages. In a preferred embodiment of the present invention, two tubular members are present. In this preferred embodiment, each of the tubular members is attached to an indexing member. Moreover, each indexing member indexes through four positions. Thus, without movement of the substrate, the tubular members may mask (and, by contrast, define) sixteen different areas. In the preferred embodiment, each of these areas overlaps each of the other areas, but by utilizing tubular members of greater length, one may use, for example, the tubular members to define areas that would not overlap. Additionally, non-overlapping areas on a substrate may be defined by defining a first area, and then by sufficiently moving the substrate relative to the tubular members to define a second area not overlapping the first area. The method of patterning non-overlapping areas may be of particular use in embodiments that place a plurality of functional patterns on a substrate.

The means for positioning a substrate may further comprise a means for holding a substrate. For example, it may be useful to attach a substrate that exhibits a significant amount of deflection from a desired position to a means for providing tension in the substrate, such as a spring means or an anchor member. The substrate may also be held, for example, by a support member having a specific coefficient of friction. The specific coefficient of friction may be selected so as to encourage the substrate to remain in substantially the same place. The support member may be located, for example, so that the substrate rests on the support member when the substrate is oriented horizontally.

The means for positioning a substrate may also comprise a means for restraining the axial motion of the substrate. This may be accomplished, for example, by providing an abutting member that provides a physical barrier to motion of the substrate in a given direction. An abutting member is most beneficial when the substrate is rigid or not easily deformable. Other ways of accomplishing this function may include means of frictionally or adhesively gripping the substrate. Thus, for example, if a means for providing tension is provided in an embodiment of the present invention, it may be desirable to combine the means for providing tension with the means for restraining the axial motion of the substrate.

The means for positioning the substrate may further comprise a means for rotating the substrate about an axis. Rotating the substrate about an axis may provide the benefit of more uniform deposition on the substrate. In the preferred embodiment, the axis that is selected is the axis of the substrate or an axis parallel to that of the substrate. Preferred rotation speeds that may be used may include, but are not limited to, between six and fifteen revolutions per minute (RPM). Additionally, it may be desirable to rotate the substrate about another axis, or to tumble the substrate through a plurality of axes simultaneously. The means for rotating may comprise, for example, a substrate holding member and a means for rotating the substrate holding member. This substrate holding member may preferably be combined with the means for holding the substrate and the means for providing tension. Additionally, the substrate holding member may also comprise the means for restraining the axial motion of the substrate.

In a particular embodiment, a means for rotating the substrate may comprise, for example, a hub. This hub may be provided with a single point of connection in the case of a single substrate, or with multiple connections in the case of multiple substrates. Thus, a hub may perform the functions of positioning the substrate, restricting the substrate's coaxial motion, and rotating the substrate. A positionable mask with apertures adjusted to the size of the substrate may be used as an example of a tubular member. The hub may be provided, for example, with a plurality of cylindrical members parallel to the axis of the substrate. The mask may be provided with corresponding openings that closely fit the cylindrical members on the hub. Thus, the mask may be slideably positioned on the hub. In a particular embodiment, the cylindrical members may be provided with irregularities in diameter corresponding to indexed positions. Thus, the cylindrical members may be used as means for mechanical indexing. The hub may be connected, for example, to a drive shaft by means of a pair of miter gears. The miter gears may provide the means for translation of rotational motion. A second hub and mask assembly may be positioned coaxially to and mirroring the first hub and mask assembly. This hub may also be connected to the drive shaft by means of miter gears. Finally, the length of the drive shaft may be adjusted to permit adjustments in the distance between the hub and mask assemblies; thus, the size of the deposition area may be varied.

Preferably, in embodiments of the present invention employing multiple substrates, the means for rotating the substrate may be accomplished by a single structure which rotates a pair of tubular members having a plurality of interior diameters, as well as rotating the means for holding the substrates.

In a preferred embodiment of the present invention, the means for rotating may comprise a driven axial member. The driven axial member is provided with rotational motion about its axis. The motion about the driven axial member's axis may then be translated to a pair of axial semi-members (e.g., two halves of a single cylinder each forming a cylinder of half the original length, separated by a distance, but arranged such that their major axes are the same). These semi-members may preferably be provided co-axially. The means of translation may comprise, for example, gears or frictional rollers.

A means of translating rotational motion may preferably provide uniform rotational motion to each of the semi-members. This balanced approach may provide the benefit of avoiding the twisting of the substrate. In particular embodiments, it may be desirable to twist the substrate. In these situations, the substrate may be twisted during rotation by, for example, choosing differing gear ratios that provide differing rotational speeds.

In another preferred embodiment, the means for positioning the substrate may further comprise a means for moving the substrate co-axially. This motion may be accomplished, for example, by providing a spooling or reeling means to move the substrate. The means may simply pull the substrate in a desired direction or may also provide for its storage. For example, as suggested by the terms spooling and reeling, the substrate may be pulled by the winding motion of a rotational member to which it is attached or frictionally coupled. The substrate may then be stored on the spool or reel.

In other embodiments, a rotational member or pair of rotational members may pull the substrate in a direction and allow it rest in a chamber defined by a structure. This structure may preferably comprise a drum or a structure with similar cylindrical or conical shape.

The means for moving the substrate co-axially may include, for example, a means for bi-directional motion. This may be accomplished by a single winding means that may be selectively wound or unwound, but preferably may comprise a pair of winding means which may be actively wound and passively wound. The passive unwinding may also provide, for example, resistance to co-axial motion, which, in turn, may provide tension in the substrate. Furthermore, the unwinding may be accomplished actively, although this may not be necessary in the preferred embodiment. In other embodiments in which the means for producing motion involves non-winding pulling, the means for producing motion may preferably be bidirectional. If non-winding means are used and an active pull is used corresponding to winding in the first example, then the passive motion may similarly provide some resistance to motion to provide tension.

Additionally, as illustrated above, this means for moving the substrate co-axially may be combined with the means for providing tension and the means for restraining the axial motion of the substrate. Moreover, the means for moving the substrate co-axially may be incorporated into the means for indexing as described above.

It may be desirable to provide the means for moving the substrate co-axially with an indexing means regardless of whether the means for moving the substrate co-axially is incorporated into the means for indexing or not. A preferable index for this motion is the length of the deposition area plus some buffer area. This buffer area may be selected as desired. In a preferred embodiment of the present invention, the buffer area is selected to be small, which has the beneficial result of increasing the number of devices or patterns which may be applied on a given length of substrate.

The means for moving the substrate co-axially may also comprise a means for deforming the substrate. The deformation may comprise, for example, stretching or squeezing. The means for accomplishing this deformation may comprise, for example, a plurality of pairs of rollers, which, in the event of a stretching deformation, may be spaced so that a second pair of rollers frictionally pulls the substrate through it more rapidly than a first pair. In the event of a squeezing deformation, the pair of rollers may be separated by a distance that is less than the diameter of the substrate, thus forcing the substrate to deform as it passes through. Finally, one roller in a pair may rotate with a greater rotational velocity than the other. The difference in rotational velocity between the two rollers in the pair may produce a bend or curl in the substrate.

In a further embodiment of the present invention, all of the means described above may be adapted to work on a plurality of substrates. In a preferred embodiment of the present invention, each tubular member has a plurality of interior diameters corresponding to a plurality of substrates. Additionally, a means for rotation may be applied to the substrates as a group; thus, all the substrates may rotate about the same axis.

In an embodiment of the present invention involving a plurality of substrates, the means for moving the substrate co-axially may also comprise means for intertwining the substrate. For example, means for intertwining may comprise means for weaving or braiding the substrate. In another embodiment, means for intertwining the substrate may comprise intertwining the substrate with a previous substrate, itself, or non-substrate material. Thus, the substrate may provide the woof and the non-substrate may provide the warp in a weaving embodiment of the intertwining means.

Substrates that may be used in the present invention include, for example, substrates that are cylindrical or conical; mono-filaments; fibers or fibrous substrates; wires; rods; ribbons or ribbon-like substrates; or strips or strip-like substrates. The substrates may comprise, for example, glass, ceramic, polymer, metal, alloy, carbon, semi-conductor, or shape memory alloy. These materials and shapes are exemplary only and not limiting. Other materials and shapes will be apparent to one skilled in the art, including tubular and irregular shapes.

For fibrous substrates, the preferred diameters of the substrate are between about one micron and about one-quarter inch. For substrates having rectangular shape, the length of the sides is preferably between about one micron and about five inches.

In an embodiment of the present invention, the process of deposition may be applied multiple times. Between depositions, the tubular members may be repositioned according to an index. This indexed displacement of the tubular members may define a plurality (including the first deposition) of subsequent depositions which may be functionally patterned by the definition provided by the tubular members. Additionally, the tubular members may be moved during deposition, if desired, to produce a layer with tapered thickness. Tapered or gradient thickness layer edges may also be produced by means of using a tubular member whose interior diameter has a shape that corresponds to that of the substrate plus the desired gradient. For instance, in the case of a circular substrate, the shape of the interior diameter may be conical. Movement during deposition, however, may be avoided in the preferred embodiment of the present invention.

As a result of this invention, the patterned films deposited on a substrate may include thin film electrochemical devices such as solid-state batteries or photovoltaic cells; thin film micro-electronic multiple interconnect devices; or other functional patterns on fibrous or ribbon-like substrates.

Additionally, the substrate may be chosen to have a complimentary or unrelated function. For example, the substrate may conduct electricity, which may be of use in certain battery or photovoltaic cell applications. Moreover, the substrate may be purely structural, possessing qualities that may only indirectly relate to the function of the device, such as rigidity, tensile strength, or ability to form a particular shape. Additionally, the substrate may be chosen to have an unrelated function, or an only distantly related function, such as, for example, an optical fiber, or a puncture resistant fiber such as, for example, a Kevlar® or Aramid® fiber. If an optical fiber is desired, the deposited device may comprise, for example, a battery that may be used to boost the optical signal as needed. If puncture resistant fiber is desired, the deposited device may comprise, for example, a battery or solar power cell and may be used as a supplemental power source for someone wearing ballistic garments. Nevertheless, while the substrate may provide multiple functions, the functions need not be related.

In certain embodiments of the present invention, the thin film materials that may be deposited on the substrate may include, for example, the following or combinations of the following: a metal, a metallic alloy, an intermetallic compound, an electronically conducting oxide, a semi-conducting oxide, an electronically conducting nitride, a semi-conducting nitride, an electronically conducting oxynitride, a semi-conducting oxynitride, an electronically conducting carbide, a semi-conducting carbide, electronically conducting carbon (partially sp2-hybridized), semi-conducting carbon (partially sp2-hybridized), III-V semi-conductor compounds, II-VI semi-conductor compounds, an electronically conducting polymeric (organic) compound, a semi-conducting polymeric (organic) compound, an electronically insulating oxide, an electronically insulating nitride, an electronically insulating oxynitride, an electronically insulating carbide, an electronically insulating carbon (mostly or at least partially sp3-hybridized), an electronically insulating chalcogenide, an electronically insulating halide, and an electronically insulating polymeric (organic) compound.

Furthermore, in certain embodiments employing three or more tubular members, a plurality of deposition areas may be defined. These areas may be adjusted by, for example, moving the tubular members. The tubular members may be enclosed in a deposition chamber, which is preferably provided with a vacuum pump to reduce the pressure of the chamber. The most preferred pressures for the chamber are between one and twenty millitorr.

A plurality of chambers may be placed sequentially. In such an embodiment of the present invention, a single substrate may pass through each of the chambers. Within each chamber, a pair of tubular members may define a deposition area. Each of these tubular members may be equipped with a means for co-axial motion. This means for co-axial motion may provide indexed motion. This means for co-axial motion may also comprise means for bi-directional motion. Preferably, this means for co-axial motion may comprise means for remote operation. This means for remote operation may be accomplished, for example, by wires controlling an electric motor. Other means for remote operation may include the transmission of electromagnetic radiation to a receiver inside the chamber. Remote operation may also be accomplished by means of pneumatics. Remote operation may provide the benefit of permitting the chamber to avoid returning to atmospheric pressure.

In an embodiment employing a plurality of chambers, a substrate may pass through each of the chambers in sequence. When a given length of the substrate resides in each chamber, deposition may take place on the area of the substrate defined by the tubular members. If it is desired that a substrate contain a plurality of identical devices, the tubular members may not have to be adjusted. In such a situation, the tubular members in each chamber may be adjusted to correspond to a given deposition layer. In other situations, a plurality of non-identical devices on a single substrate may be desired. In this situation, the tubular members may be adjusted prior to each deposition (or as previously discussed, during deposition, if desired).

Additionally, in embodiments employing a plurality of deposition chambers, each chamber may be equipped with a means of deposition. This means of deposition may deposit a single material or may selectably deposit a plurality of materials. In embodiments employing a plurality of chambers, unlike an embodiment employing a single chamber, the means of deposition preferably may deposit a single material, which may comprise materials that are compounds, mixtures (homogenous and heterogeneous), and alloys. Generally, any material that may be applied in a single deposition is included. Thus, for example, if cadmium sulfide were to be deposited in a single deposition than it would be considered a single material; whereas, if both cadmium and sulfur were to be deposited, but not simultaneously, the material deposited would not consist of a single material.

In embodiments employing a plurality of deposition chambers, each having a means of deposition, the chambers may preferably be arranged so that a substrate passing through each chamber will pass through the chamber provided with a means of depositing the material for the layer closest to the substrate first. Subsequent layers to be deposited may preferably be similarly arranged.

In embodiments employing a plurality of deposition chambers, each having a means of deposition, the order in which materials are to be deposited may vary according to what functional pattern is sought in the deposition of multiple layers. Thus, the means for moving the substrate co-axially may preferably comprise a means for bi-directional movement.

A means for deposition may be provided to deposit material onto the substrate. This means for deposition may comprise, for example, a sputter plasma (RF, AC, or DC) technique, electron beam evaporation processing, cathodic arc evaporation, chemical vapor deposition, or plasma enhanced chemical vapor deposition. Sputtering processes are the preferred technique for deposition. Sputtering may preferably be accomplished under a pressure of between approximately one and approximately twenty millitorr. A hollow cathode sputter or a cathodic arc technique may preferably be accomplished under a pressure of between approximately 0.1 and approximately twenty millitorr. Typical preferred evaporation pressures are between about 0.01 and about 0.1 millitorr. Typical chemical vapor and plasma enhanced chemical vapor deposition pressures are between about ten millitorr and atmospheric pressure. Source powers for RF, AC, and DC sputtering may be, for example, in the approximate range of fifty to three hundred Watts on about a sixty square centimeter target. A useful target to axis of rotation distance may be, but is not limited to, approximately 2.25 inches. Individual or multiple electron beam pocket sources, or a single linear beam evaporation trough, for example, may be utilized.

Although some means of deposition may have inherently limited areas of deposition, these areas may be expanded by accomplishing a relative motion between the tubular members, the substrate, and the means of deposition. Alternatively, multiple means of deposition may be combined to provide a larger possible deposition area. It is preferable that the deposited material not be wasted by being deposited on non-substrate; however, the possible deposition area may generally include at least a portion of the tubular members.

Members of the apparatus of the present invention may be manufactured from available materials. Preferred materials for members that are exposed to plasma and vapor include stainless steel and aluminum. Other metals, metal alloys, machinable ceramics, and high temperature plastics may be utilized. Other materials providing suitable structure that can survive the environment associated with deposition may also be used.

Furthermore, in embodiments of the present invention employing a plurality of deposition chambers, it may be desirable to separate the chambers from one another by means of a buffer zone. This zone may comprise, for example, a chamber equipped with a vacuum pump. The use of a buffer zone may have the beneficial result of preventing cross-contamination between chambers. Additionally, means for entrance and egress by the substrate with regard to the chambers may be provided with a means for isolating conductance.

Additionally, in some instances, it may be beneficial to pre-sputter prior to deposition, which may result in the removal of interstitial materials and the formation of reactive surface properties on, for example, compound target surfaces. This step of pre-sputtering may be accomplished by the described apparatus further comprising a plasma shutter means. This plasma shutter means may comprise a physical member, such as a semi-cylindrical member, which may be rotated or otherwise positioned to shield or expose the substrate.

Additional patterning methods may be applied after deposition or between depositions. These techniques may include laser ablation or chemical or mechanical etching. Additionally, photolithographic film masking, if utilized, may involve chemical or e-beam lithographic means for removal of the photoresist after each deposition. Avoiding damage to the substrate may present some challenges in these situations.

Functional patterns may be described in terms of a discretely indexed deposition process. Discrete indexing may not be necessary, but may provide the benefit of consistent results in output. The index used is preferably an ordinal index, based on a length-wise view of a cross section of a substrate. The index, from left to right along the length of the substrate, may start at L4 and then proceed to L3, then to L2, then to L1. These indexing positions may be followed by R1, then R2, next R3, and finally R4. There is no requirement that there only be eight indexed positions, or that the number of indexed position on the left and right be equal. Moreover, the difference in position between any two consecutive indexed positions may be different from the difference between the position of two other consecutive indexed positions. In a preferred embodiment, L4 is separated from L3 by about 0.25 inches, L3 is preferably separated from L2 by about 0.25 inches, and L2 is preferably separated from L1 by about 0.25 inches. Thus, the interposition separation of L1, L2, L3, and L4 is 0.25 inches. In the preferred embodiment, R4 is separated from R3 by about 0.25 inches, R3 is preferably separated from R2 by about 0.25 inches, and R2 is preferably separated from R1 by about 0.25 inches. Thus, the interposition separation of R1, R2, R3, and R4 is 0.25 inches. Finally, in a preferred embodiment, the distance between L1 and R1 may be between approximately 2.0 inches and approximately 7.0 inches.

In a particular example of a lithium-free battery, the substrate may comprise, for example, an alumina fiber. The first layer to be deposited may be a cathode current collector. This cathode current collector layer may comprise, for example, chromium. The cathode current collector layer may be deposited between L1 and R4. Next, the cathode layer may be deposited. The cathode layer may comprise, for example, amorphous Li_{1.6}Mn_{1.8}O₄ and may be deposited between L1 and R1. Next, the electrolyte layer may be deposited. The electrolyte layer may comprise, for example, Lipon and may be deposited between L2 and R2. Next, an electrode layer, which in this instance provides an auxiliary anode layer and anode current collector, may be deposited. The electrode layer may comprise, for example, copper and may be deposited between L4 and R1. Next, the protectant layer may be deposited. The protectant layer may comprise, for example, Lipon and may be deposited between L3 and R3.

In a particular example of a buried lithium-free battery, the substrate may comprise, for example, an alumina fiber, a copper fiber, or a glass fiber. The first layer to be deposited may be an anode current collector. This anode current collector layer may comprise, for example, chromium and may be deposited between L4 and R4. Next, the electrolyte layer may be deposited. The electrolyte layer may comprise, for example, Lipon and may be deposited between L3 and R3. Next, the cathode layer may be deposited. The cathode layer may comprise, for example, amorphous Li_{1.6}Mn_{1.8}O₄ and may be deposited between L1 and R1. Next, an electrode layer, which may be used to provide an auxiliary cathode layer, may be deposited. The electrode layer may comprise, for example, chromium and may be deposited between L1 and R1. Next, a cathode current collector layer may be deposited. The cathode current collector layer may comprise, for example, copper and may be deposited between L1 and R1.

A particular example of a functional pattern may be a copper-indium-gallium-selenide (CIGS) photovoltaic device configuration. At its core may be, for example, a 100 micron insulating fiber. On the fiber and between L1 and R4 may be, for example, a 0.5 micron bottom cell contact layer of molybdenum. On the molybdenum layer and between L1 and R3 may be, for example, a 2.0 micron layer of p-type absorber, such as, for example, a copper-indium-gallium-selenide device. On the p-type absorber layer and between L2 and R3 may be, for example, a 0.05 micron layer of CdS. On the CdS layer and between L4 and R2 may be, for example, a 0.6 micron top cell contact layer of transparent conductive oxide, such as, for example, indium-tin oxide.

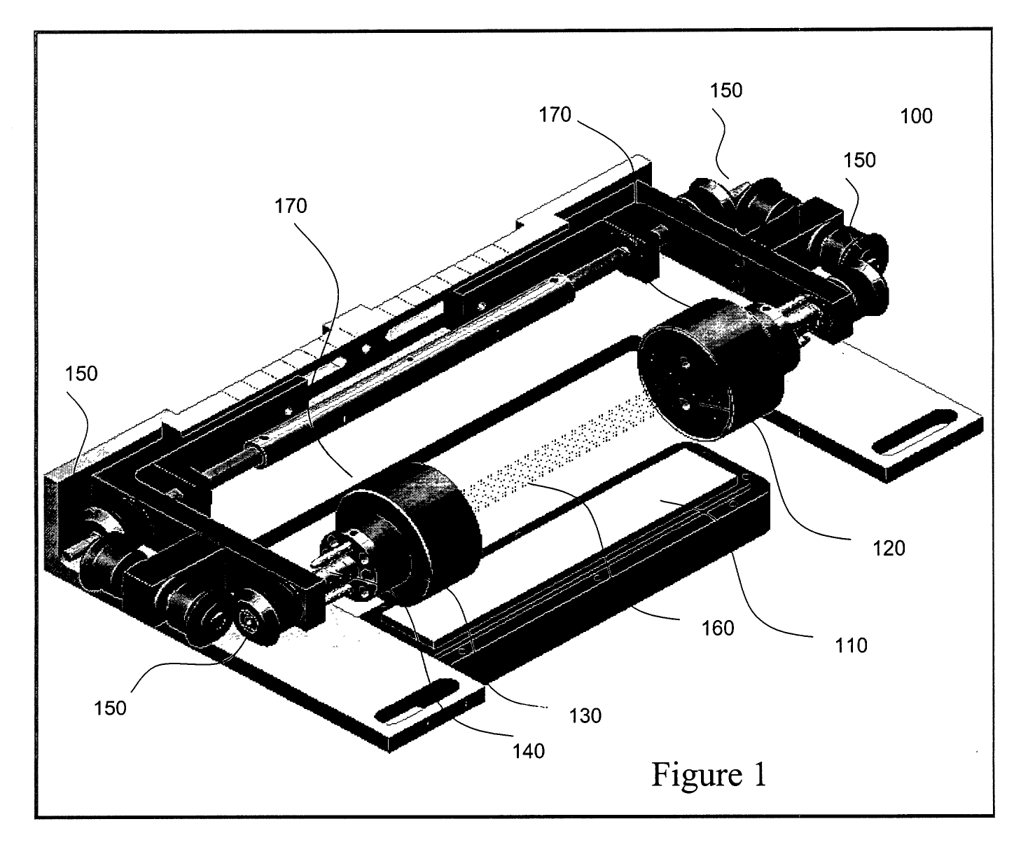

FIG. 1 is a perspective view diagram of a preferred embodiment of the present invention. FIG. 1 illustrates an embodiment of the tubular member 120, means for positioning 130 the substrate 160 and means for rotating 140 the substrate 160, of the present invention. This may be described, for example, as a rotating fiber fixture 100 with masking capability for use in deposition of thin films. Also shown is an RF-DC sputtering target assembly 110 that may be employed, for example, during deposition. The assembly of members shown may be referred to as the fixture 100. This is not meant to imply any further limitation. The fixture 100 may be fabricated from stainless steel and aluminum. Other metals, metal alloys, machinable ceramics, and high temperature plastics may also be utilized. Stainless steel may, preferably, be utilized predominantly in the tubular member 120 and means for positioning 130 the substrate 160, which may be largely exposed to plasma and vapor of such depositions. A means for producing rotational motion, such as, for example, a rotational drive, may be connected at either end of the fixture's miter gearing 150, which, in this instance, provides the means for transferring rotational motion. This fixture 100 may allow flexibility in substrate 160 patterning lengths by the ability to increase or decrease the distance between means for positioning 130 the substrate 160, such as, in this example, the hub 170 (including means for positioning 130, and means for shadow masking such as tubular members 120). In other words, completed functional patterns may be, for example, as short as about 3.50 inches in length, and as long as about 9.50 inches in length. This ability may allow for the tailoring of a variety of functional pattern attributes, such as specific application interconnect, composite, or device length, resistance and/or conductivity requirements, or electrochemical cell capacities, among others. The fixture 100 also may avoid the requirement of a center shaft in the substrate deposition region, or in the plasma. Thus, nonuniform deposition due to fixture shadowing may be avoided. For ease of substrate 160 insertion into the fixture 100, the means for positioning 130 the substrate 160 are, in this instance, designed to be removed easily.

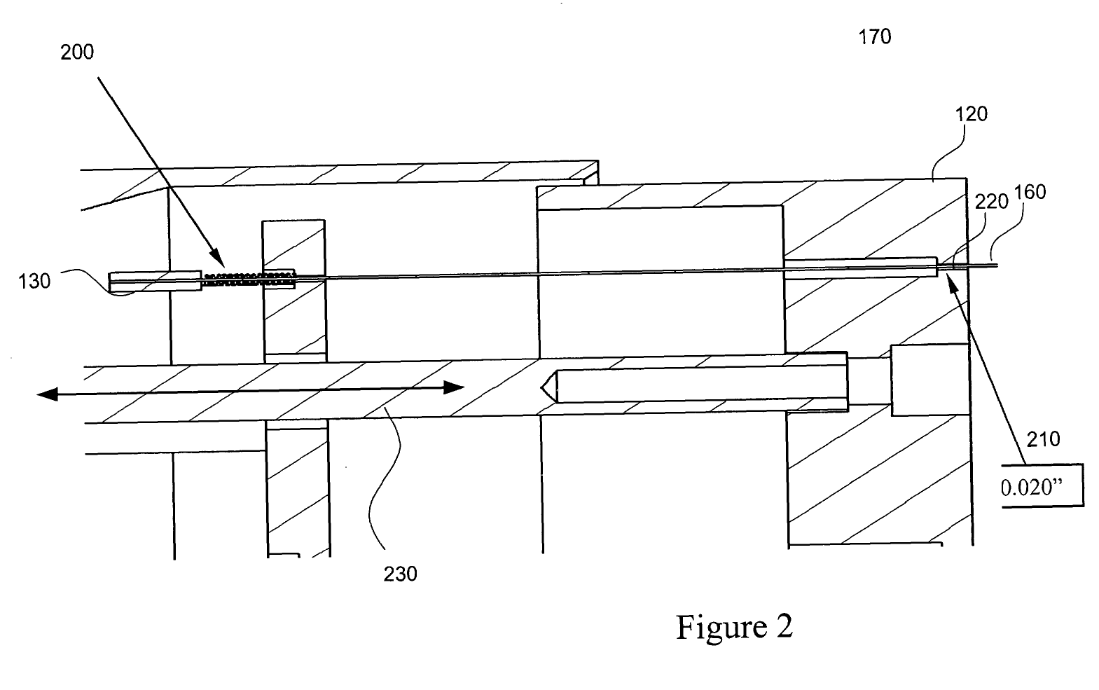

FIG. 2 is a partial cut-away diagram of a preferred embodiment of the present invention. FIG. 2 displays a substrate 160 threaded through a tubular member 120 and through and to a means for positioning 130 the substrate 160, such as, in this example, a hub 170. In this example, the substrate 160 is held in place by a member that provides means for positioning 130 and that also provides tension by means of a spring 200. The 0.020 inch interior diameter 210 of the tubular member 120 is arbitrary in that larger or smaller diameters may be utilized as effectively. The 0.063 inch length 220 co-axially of the tubular member 120 at the interior diameter 210 is arbitrary as well. The linear bearing guided shafted tubular member 120 (which may also be referred to as a mask) supports 230 and substrate positioning techniques may be designed to minimize substrate 160 (for example, fiber) contact with the tubular member 120 (or mask) during co-axial repositioning. The interior diameter 210 (which may be referred to as an orifice) may be machined and subsequently deburred to eliminate damage to deposited thin films if any substrate 160 contact is made during the repositioning of the tubular member 120 for subsequent depositions.

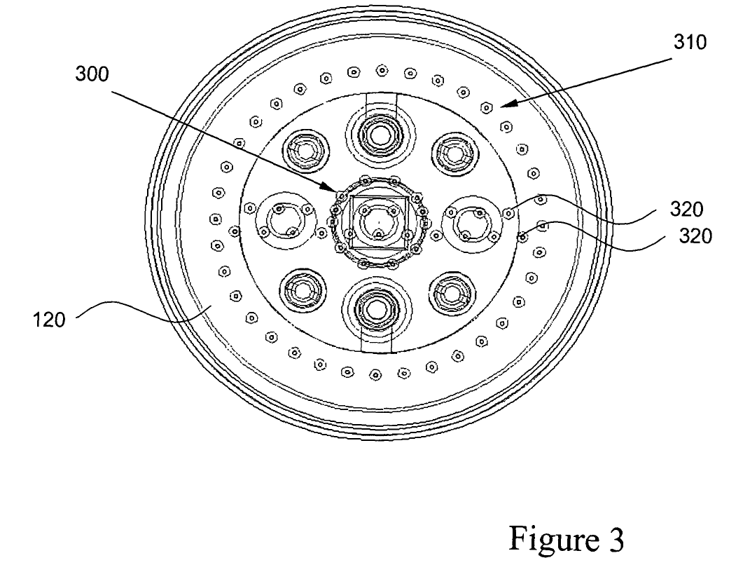

FIG. 3 is an axial view diagram of an example of a tubular member 120 having a plurality of interior diameters 300, 310, 320. FIG. 3 illustrates available circular 300, 310 and linear 320 ways of arranging multiple interior diameters 300, 310, 320 on a single tubular member 120. The radii of these arrays of interior diameters 300, 310 may include, for example, 0.50 inches and 1.75 inches. The present invention does not preclude other diameters, which may provide, for example, the ability to vary the number of uniformly coated fibers or wires. In the preferred embodiment, substrate array diameters 300, 310 or linear patterns of array diameters 320 may be fully contained within a uniform vapor or plasma stream. In an embodiment as shown in FIG. 3, the substrate (not shown) may extend through the array of interior diameters 300, 310, 320 shown. The shape and size of these interior diameters 300, 310, 320 is shown for a substrate that has a narrow, circular, and invariant cross-section. In this depiction, the axis of the substrate would extend perpendicular to the printed page.

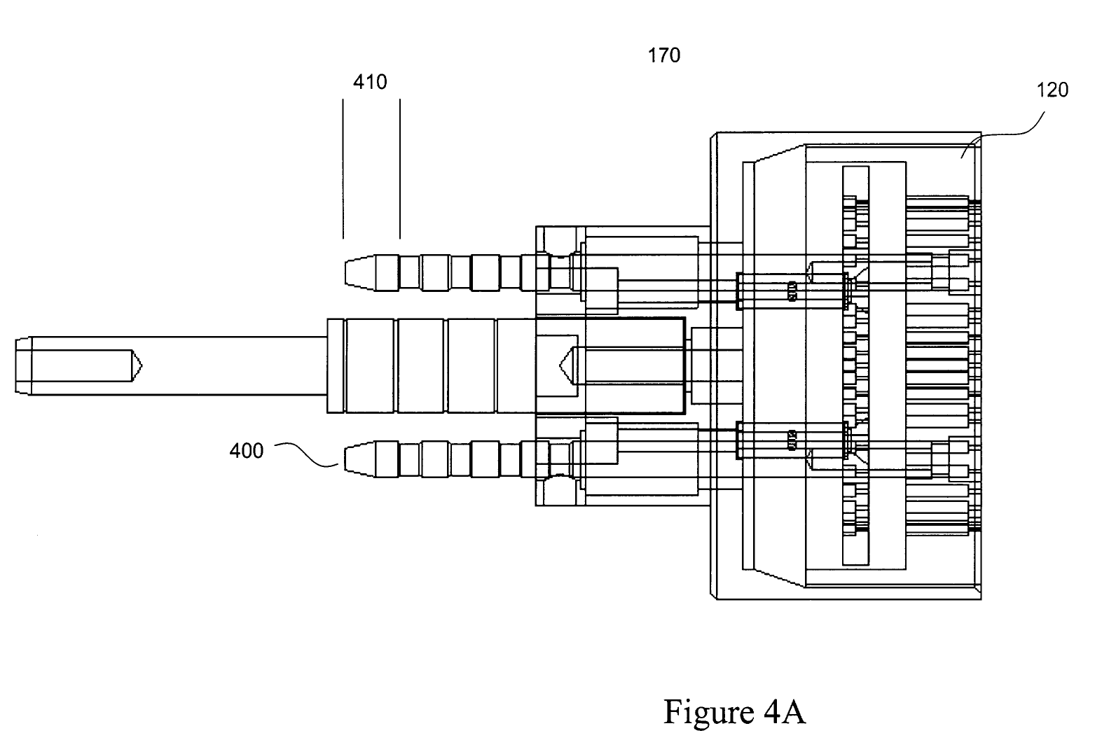

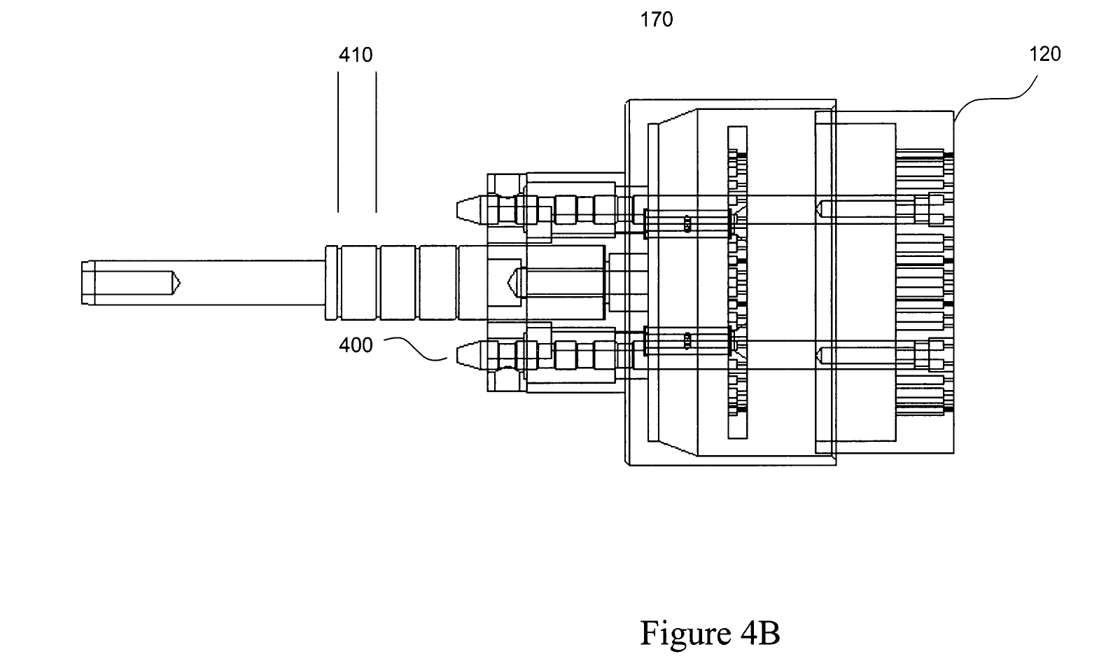

FIG. 4a is a look-through diagram of an example of a tubular member 120 and means for indexing 400 with the tubular members 120 (e.g., a mask and hub assembly, or fixture 100) in a “fully contracted” position. FIG. 4b is a look-through diagram of an example of a tubular member 120 and means for indexing 400 with the tubular members 120 in a “fully extended” position. Tubular member 120 may be adjusted, in the example shown, in indexed 0.25 inch increments 410 (each end) to selectively shutter portions of the substrate (not shown) for each deposition. This invention does not preclude other indexed lengths of increments. Indeed, the ability to tailor the size of the deposition area is a key attribute to the present invention. Additionally, this invention does not preclude increasing or decreasing the number of indexed positions 410 available.

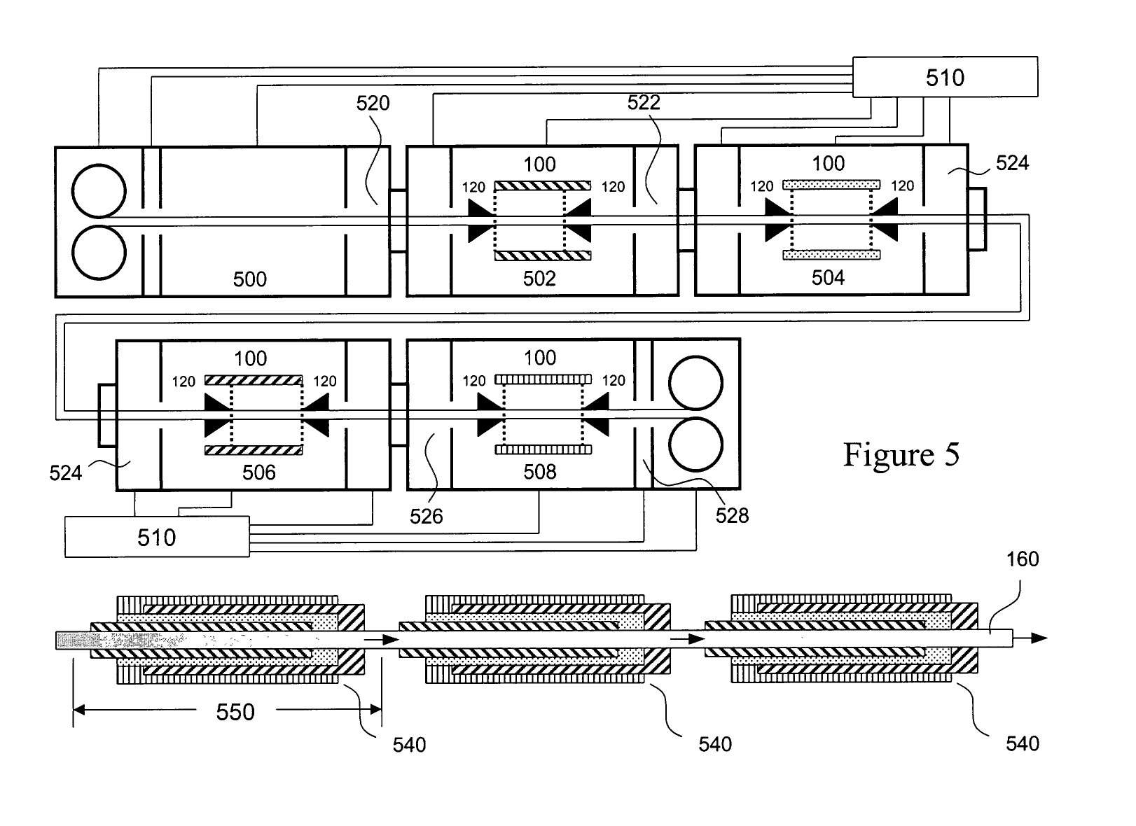

As shown in FIG. 5, a series of in-line deposition chambers 500, 502, 504, 506, 508 may be assembled involving chamber specific means for vacuum pumping 510 and conductance isolation. Buffer zones 520, 522, 524, 526, 528 may be provided between each of the chambers 500, 502, 504, 506, 508, that may permit the isolation of reactive versus non-reactive simultaneous plasma or vapor depositions. Each of the in-line deposition chambers 500, 502, 504, 506, 508 may contain a remotely controlled apparatus for non-contact, linearly bi-directional shadow masking, or fixture 100. As a result, in-situ multilayer and patterned depositions may be performed without venting chambers to atmosphere. Uniformly deposited multilayer patterned devices 540 may be of virtually any length. This plurality of non-contact, linearly bi-directional shadow masking apparatuses, or fixtures 100 may be driven in unison with respect to substrate rotation, if required. This plurality of non-contact, linearly bi-directional shadow masking apparatuses, or fixtures 100 may be individually enabled to linearly adjust the position of each tubular member 120 (not shown), thus permitting maximum flexibility in the patterning of multilayer functional patterns 540. In continuous deposition of multiple and multilayer patterned devices 540 on a substrate 160 such as a single fiber monofilament or strip, the substrate 160 may be indexed with respect to the co-axial motion, for a distance corresponding to the length 550 of the desired functional pattern 540. Non-contact, linearly bi-directional tubular members 120 may be individually, and deposition-specifically, positioned.

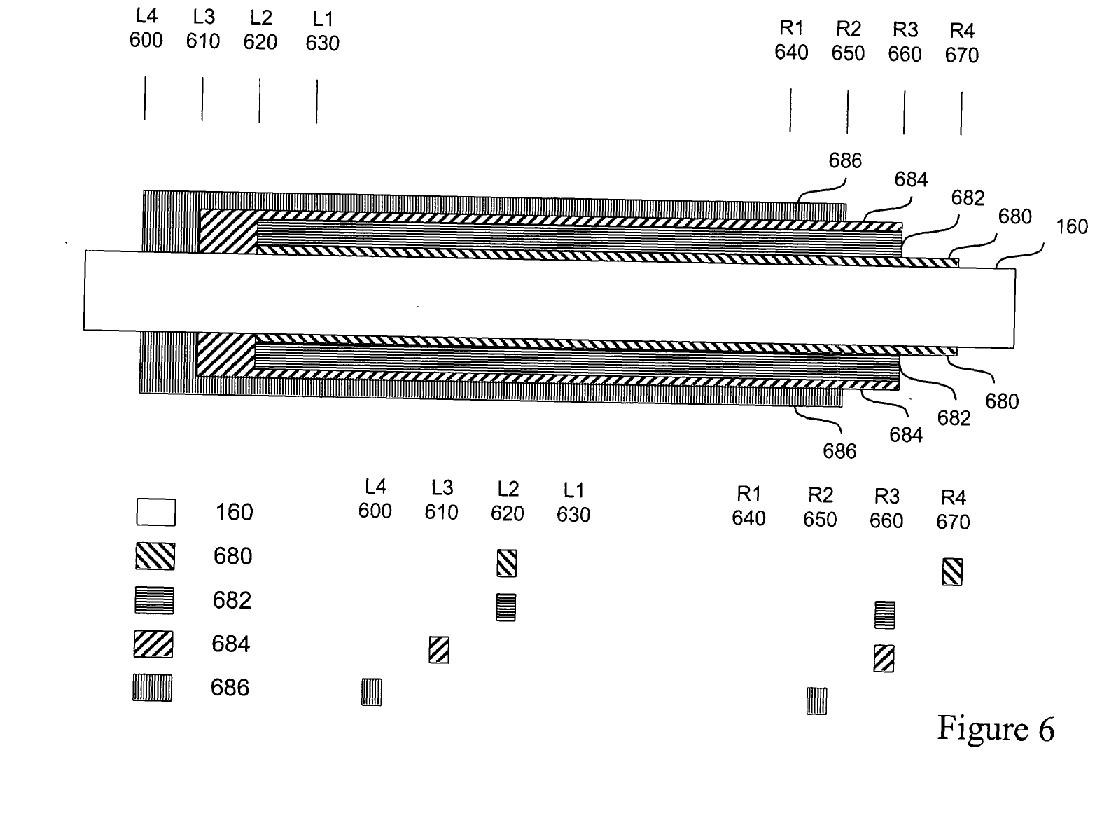

FIG. 6 is a length-wise cutaway diagram of a CIGS photovoltaic device configuration. At its core may be, for example, a 100 micron insulating fiber, which serves as the substrate 160. On the substrate 160 and between L2 620 and R4 670 may be, for example, a 0.5 micron bottom cell contact layer of molybdenum 680. On the molybdenum layer 680 and between L2 620 and R3 660 may be, for example, a 2.0 micron layer of p-type absorber 682, such as, for example, a CIGS. On the p-type absorber layer 682 and between L3 610 and R3 660 may be, for example, a 0.05 micron layer of CdS 684. On the CdS layer 684 and between L4 600 and R2 650 may be, for example, a 0.6 micron top cell contact layer of transparent conductive oxide 686, such as, for example, indium-tin oxide. In this diagram, the axis of the substrate 160, extends from left to right across the page.

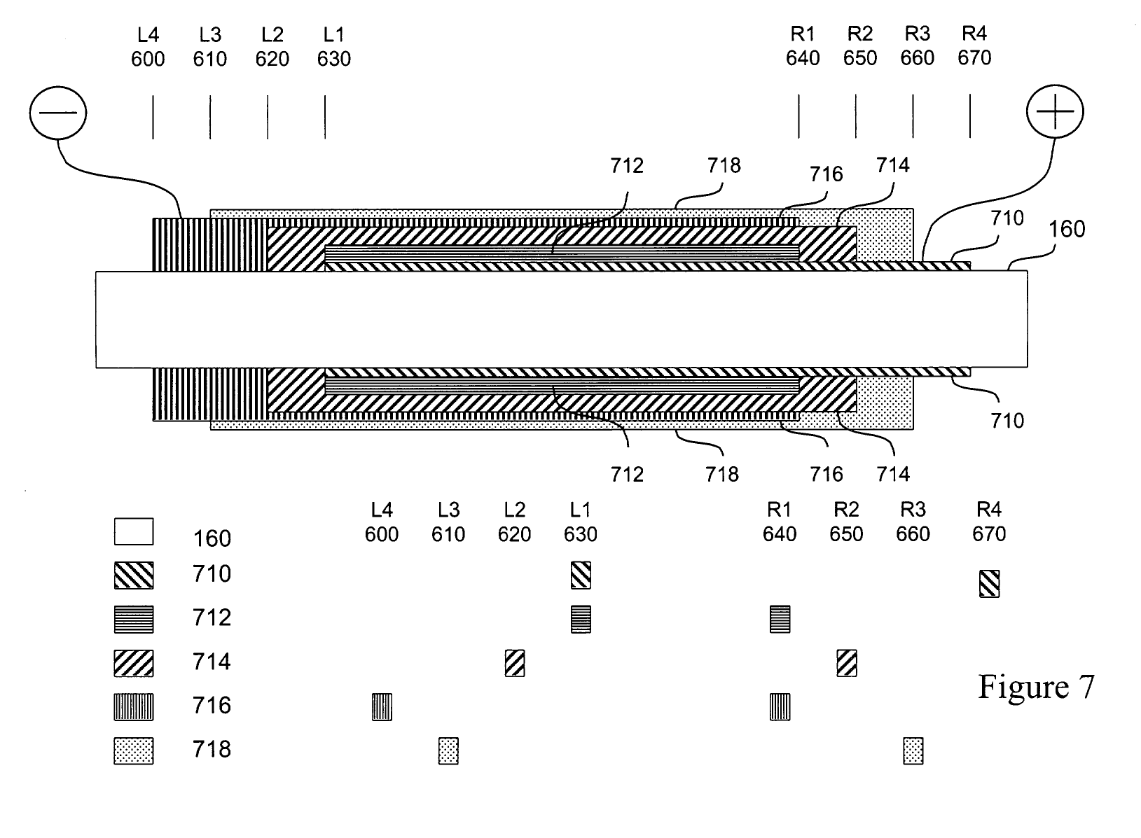

FIG. 7 is a length-wise cutaway diagram of a lithium-free battery configuration. At its core may be, for example, a 150 micron alumina fiber, which serves as a substrate 160. On the substrate 160 and between L1 630 and R4 670 may be, for example, a 0.3 micron layer of chromium 710. On the chromium layer 710 and between L1 630 and R1 640 may be, for example, a 1.4 micron layer of Li_{1.6}Mn_{1.8}O₄ 712. On the Li_{1.6}Mn_{1.8}O₄ layer 712 and between L2 620 and R2 650 may be, for example, a 1.5 micron layer of Lipon 714. On the Lipon layer 714 and between L4 600 and R1 640 may be, for example, a 2.0 micron layer of copper 716. On the copper layer 716 and between L3 610 and R3 660 may be, for example, a 0.3 micron layer of Lipon 718. In this diagram, the axis of the substrate 160, extends from left to right across the page.

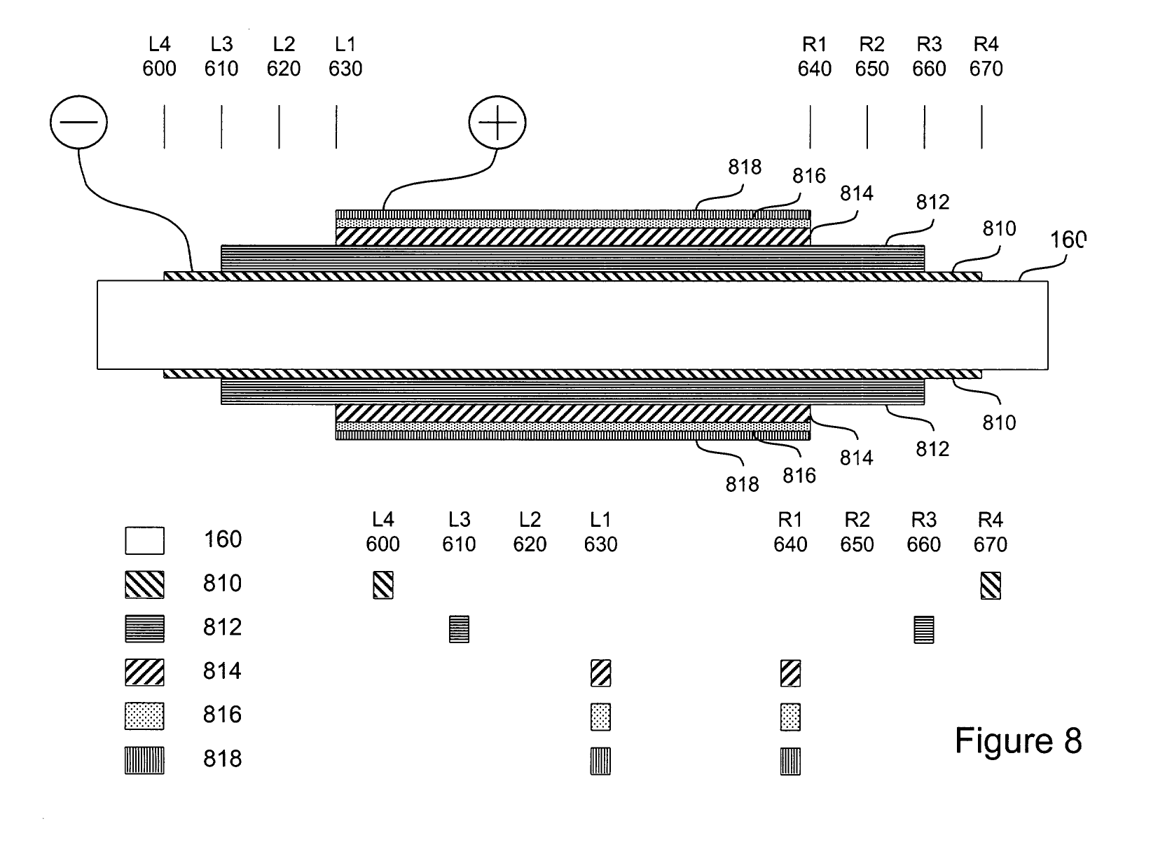

FIG. 8 is a length-wise cutaway diagram of a buried lithium-free battery configuration. At its core may be, for example, a 150 micron alumina fiber, a 100 micron copper fiber, or 100 micron glass fiber, or a 150 micron sapphire fiber; this fiber may serve as a substrate 160. On the substrate 160 and between L4 600 and R4 670 may be, for example, a 1.0 micron layer of chromium 810. On the chromium layer 810 and between L3 610 and R3 660 may be, for example, a 2.0 micron layer of Lipon 812. On the Lipon layer 812 and between L1 630 and R1 640 may be, for example, a 1.0 micron layer of Li_{1.6}Mn_{1.8}O₄ 814. On the Li_{1.6}Mn_{1.8}O₄ layer 814 and between L1 630 and R1 640 may be, for example, a 0.5 micron layer of chromium 816. On the chromium layer 816 and between L1 630 and R1 640 may be, for example, a 0.5 micron layer of copper 818. In this diagram, the axis of the substrate 160, extends from left to right across the page.

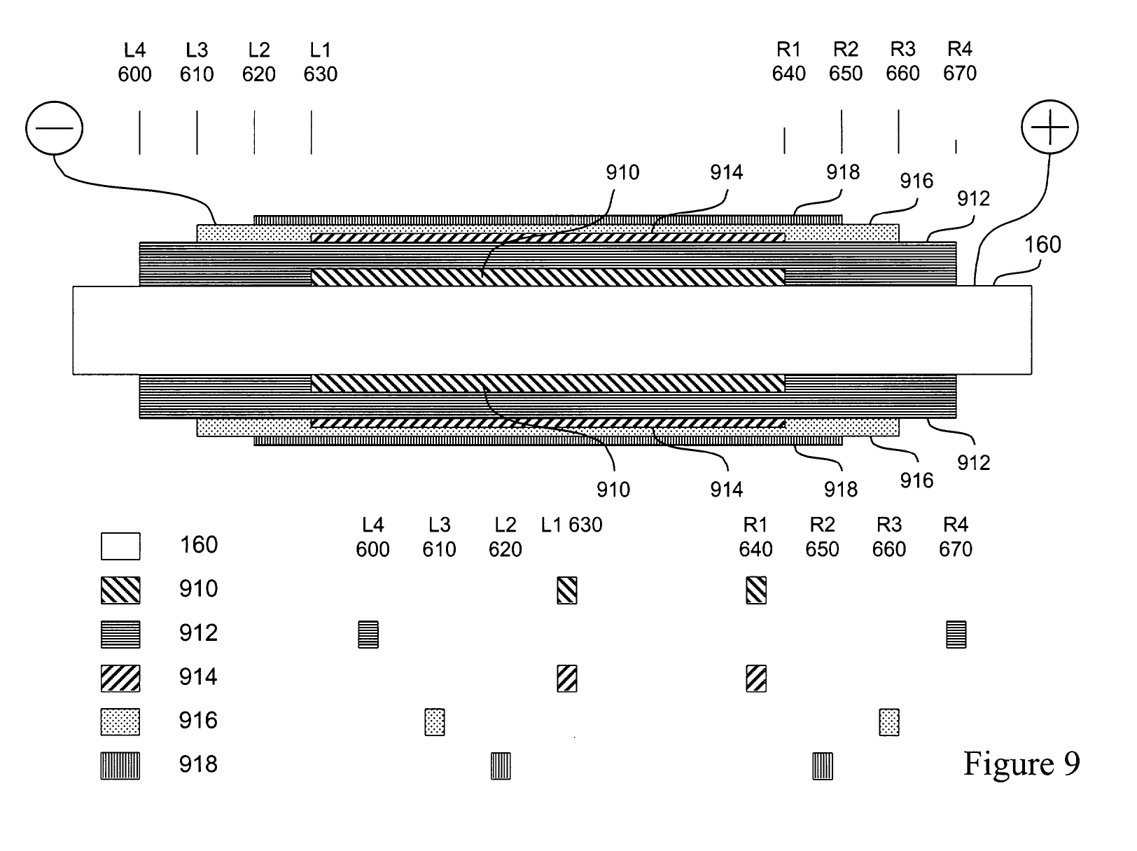

FIG. 9 is a length-wise cutaway diagram of a lithium-ion battery configuration. At its core may be, for example, a 100 micron copper or Iconel® 600 fiber, which may serve as a substrate 160. On the substrate 160 and between L1 630 and R1 640 may be, for example, a 1.0 micron layer of Li_{1.6}Mn_{1.8}O₄ 910. On the Li_{1.6}Mn_{1.8}O₄ layer 910 and between L4 600 and R4 670 may be, for example, a 2.0 micron layer of Lipon 912. On the Lipon layer 912 and between L1 630 and R1 640 may be, for example, a 0.1 micron layer of Sn₃N₄ 914. On the Sn₃N₄ layer 914 and between L3 610 and R3 660 may be, for example, a 0.2 micron layer of copper 916. On the copper layer 916 and between L2 620 and R2 650 may be, for example, a 0.2 micron layer of Lipon 918. In this diagram, the axis of the substrate 160, extends from left to right across the page.

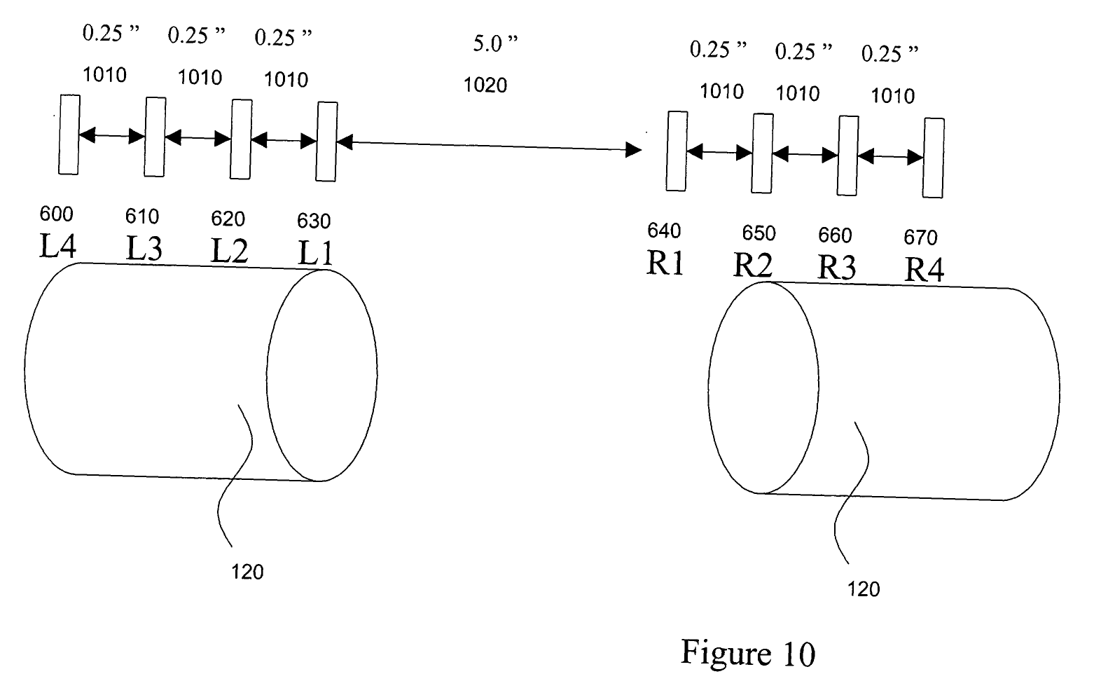

FIG. 10 is a stylized depiction of the operation of a discrete deposition indexing method. In this example, eight positions are indexed (L1 630, L2 620, L3 610, L4 600, R1 640, R2 650, R3 660, R4 670); however, this number of positions, although convenient in a preferred embodiment of the present invention are merely an example. Additionally, the provided spacing 1010, 1020 is exemplary only, and may be tailored as desired. In particular, the spacing 1020 between L1 630 and R1 640 may generally dominate and determine the overall length of the functional pattern. The tubular members 120 (which may be referred to as cylindrical members) shown are representations of a pair of tubular members 120 in the indexed positions L1 630 and R2 650 respectively. In this diagram, the substrate 160 is not shown.

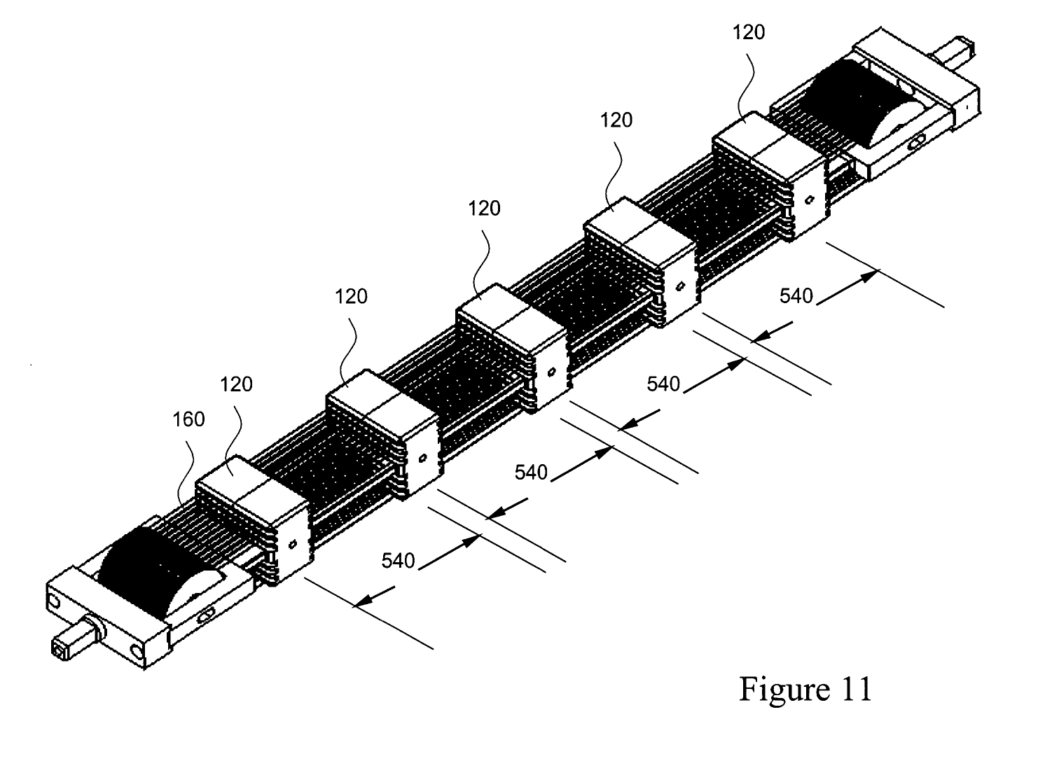

FIG. 11 is a perspective view diagram of an embodiment of the present invention employing a plurality of tubular members 120 (which may be referred to as shadow masks). The embodiment shown may, for example, employ substrate 160, which may be a single fiber wound continuously on, for example, a pair of means for positioning the substrate. This means for positioning may further comprise array spacers on a spool (not visible in this depiction). The array spacers may comprise comb-like structures that separate consecutive windings of a continuous substrate by forced mechanical separation. Alternatively, the substrate may be wound around several independent spools, which may form a pulley like system. Such a system may provide spacing among segments of the substrate as well as ensuring tension in each segment. A plurality of shadow masks, for example, tubular members 120 may be applied to mask one or more portions of the substrate. These masks may be applied in halves from the sides of the substrate. When patterns of differing lengths are required, different size masks may be applied. Another way to achieve a similar result would be to permit the masks to be adjustable in the amount of area of the substrate that they mask. However, the use of removable masks that may be applied from the side may be a simpler technique. The result may be a single substrate 160 with a large number of similar functional patterns 540.

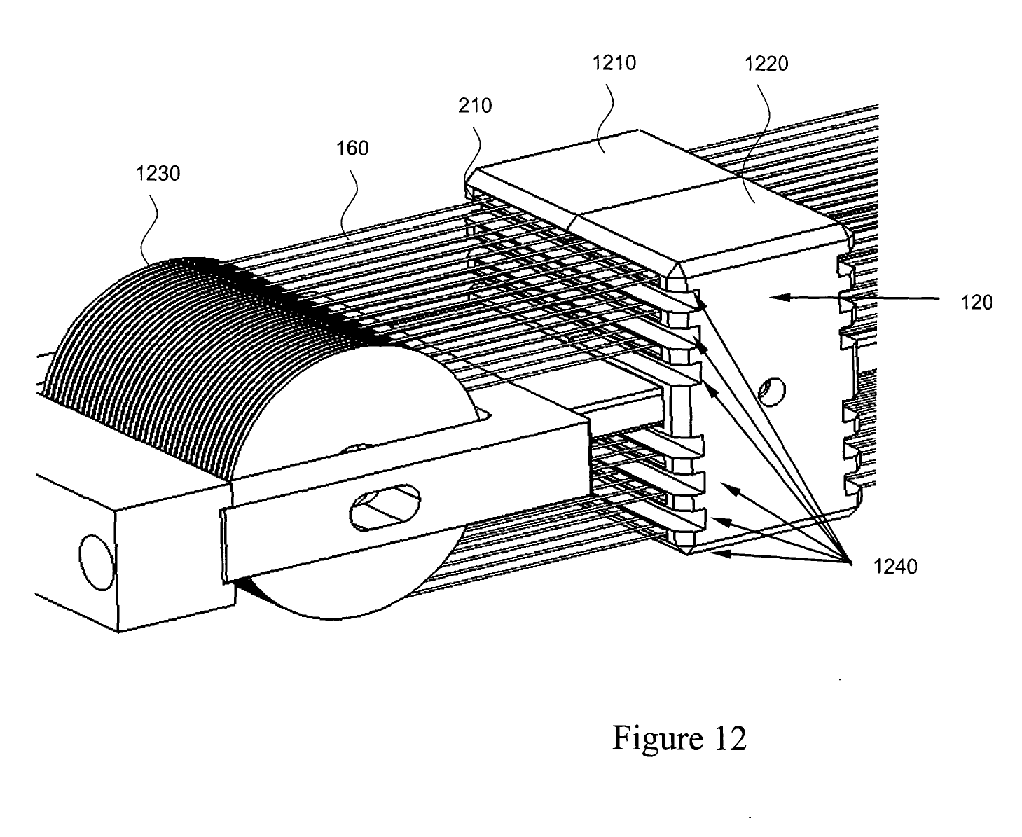

FIG. 12 is a partial perspective view diagram of an embodiment of the present invention employing a two-piece, slot-shaped inner diameter or aperture 210. The figure shows an embodiment in which a two-piece slot-shaped inner diameter 210 may be used. To specify the size of a deposited layer, the shadow mask (in this example, a tubular member 120) may be selected to be a particular size. The tubular member 120 may, in this example, be removed by separating the two pieces 1210, 1220 in a direction cross-wise to the substrate 160. In the depicted embodiment, one substrate 160 (a ribbon or fiber) wound on three diameters 1230 results in six linear rows 1240 of substrates 160 for deposition.

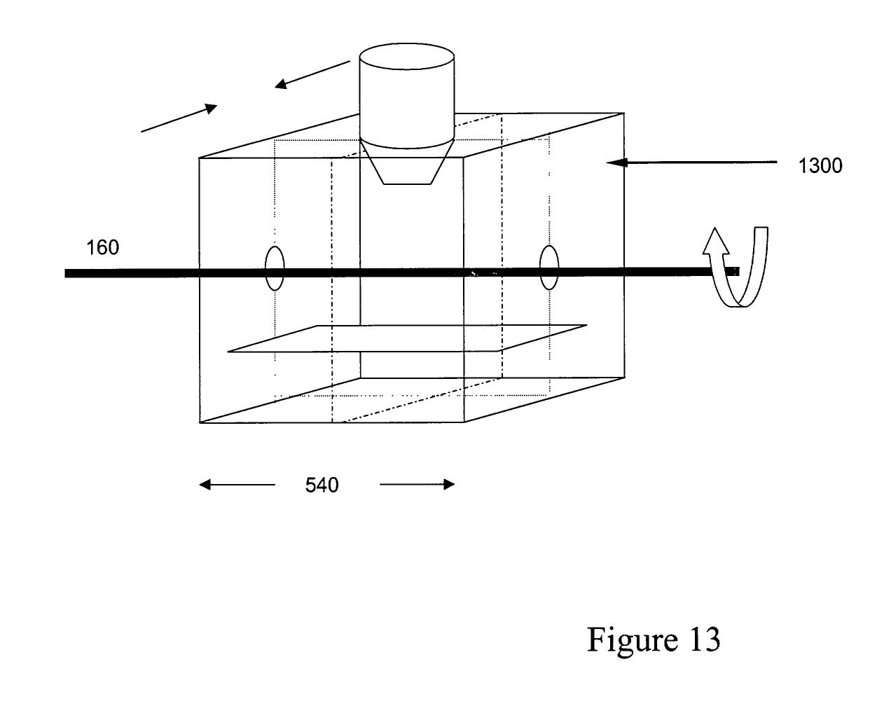

FIG. 13 is a stylized look-through depiction of an embodiment of the present invention wherein the shadow mask is a non-tubular member 1300. In this depiction, the vacuum deposition chamber, non-tubular member 120, also provides the means of shadow masking. The size of the pattern 540 may, for example, be controlled by disposing the substrate 160 in an appropriately sized vacuum deposition chamber (non-tubular member 1300), or by controlling the size of the deposition chamber (non-tubular member 1300).

Other embodiments of the invention will be apparent to those skilled in the art from consideration of the specification and the practice of the invention disclosed herein. It is intended that the specification and examples be considered as exemplary only, with a true scope and spirit of the invention being indicated by the following claims.

What is claimed is:

1. A method of depositing a patterned thin film on a fibrous substrate comprising the steps of:
providing said fibrous substrate having a length, a surface area, a cross-section, and an axis perpendicular to said cross-section,
providing means for shadow masking,
positioning said fibrous substrate in a masked position relative to said means for shadow masking, and
depositing a thin film material on at least a portion of said surface area of said fibrous substrate.

2. The method of claim 1, wherein said step of depositing a thin film material comprises depositing a multi-layer thin film material.

3. The method of claim 1, wherein said fibrous substrate comprises a substantially circular cross-section.

4. The method of claim 3, wherein the diameter of said cross-section is between approximately 1 micron and approximately one-quarter inch.

5. The method of claim 1, wherein said fibrous substrate comprises an elliptical cross-section.

6. The method of claim 5, wherein a diameter of said cross-section is between approximately 1 micron and approximately one-quarter inch.

7. The method of claim 1, wherein said fibrous substrate comprises a substantially rectangular cross-section.

8. The method of claim 7, wherein a side of said cross-section is between approximately 1 micron and approximately five inches.

9. The method of claim 1, wherein said fibrous substrate comprises a ribbon-like substrate.

10. The method of claim 1, wherein said cross-section is dynamic.

11. The method of claim 10, wherein said dynamic cross section comprises variations along said length of said fibrous substrate.

12. The method of claim 10, wherein said dynamic cross section comprises variations in time.

13. The method of claim 1, wherein said fibrous substrate is a means for one or more functions selected from a group consisting of
thermal insulation,
thermal conduction,
electrical insulation,
electrical conduction,
charge storage,
magnetic field storage,
optical transmission,
shadowing,
data transmission,
data storage,
provision of structural rigidity,
provision of structural flexibility,
provision of static structural shape,
provision of dynamic structural shape,
provision of tensile strength,
provision of compressive strength,
electromagnetic energy absorption,
electromagnetic energy reflection,
liquid absorption,
liquid transmission,
liquid storage,
gas absorption,
gas transmission,
gas storage,
fuel absorption,
fuel transmission, and
fuel storage.

14. The method of claim 1, wherein said fibrous substrate comprises copper.

15. The method of claim 14, wherein said fibrous substrate comprises a diameter of approximately 100 microns.

16. The method of claim 1, wherein said fibrous substrate comprises Iconel 600.

17. The method of claim 16, wherein said fibrous substrate comprises a diameter of approximately 100 microns.

18. The method of claim 1, wherein said fibrous substrate comprises an optical fiber.

19. The method of claim 18, wherein said optical fiber comprises a diameter of approximately 100 microns.

20. The method of claim 1, wherein said fibrous substrate comprises a material selected from a group consisting of glass, ceramic, sapphire, polymer, metal, metal alloy, carbon, semiconductor, shape memory alloy, and polished naturally occurring fibers.

21. The method of claim 20, wherein said polished naturally occurring fibers comprise a material selected from a group consisting of wool, cotton, hemp, and wood.

22. The method of claim 1, wherein said fibrous substrate comprises a length of between one inch and four feet.

23. The method of claim 1, wherein said fibrous substrate comprises a length greater than four feet.

24. The method of claim 23, wherein said fibrous substrate comprises a length greater than 100 feet.

25. The method of claim 23, wherein said fibrous substrate comprises a length greater than 1000 feet.

26. The method of claim 1, wherein said step of providing a fibrous substrate comprises providing a means for storing said fibrous substrate.

27. The method of claim 26, wherein said means for storing said fibrous substrate comprises a means selected from the group consisting of
a spool,
a reel, and
a drum.

28. The method of claim 26, wherein said step of providing said substrate in a masked position further comprises said means for storing said fibrous substrate.

29. The method of claim 1, wherein said positioning said fibrous substrate comprises positioning said substrate co-axially.

30. The method of claim 29, wherein said step of positioning said fibrous substrate comprises preventing co-axial motion of said substrate.

31. The method of claim 29, wherein said step of positioning said fibrous substrate comprises providing tension in said substrate.

32. The method of claim 29, wherein said step of positioning said fibrous substrate comprises providing compression in said substrate.

33. The method of claim 29, wherein said step of positioning said fibrous substrate comprises moving said fibrous substrate co-axially.

34. The method of claim 33, wherein said step of moving said fibrous substrate co-axially comprises indexing said step of moving said fibrous substrate co-axially.

35. The method of claim 34, wherein said step of indexing comprises providing a discrete index.

36. The method of claim 35, wherein said discrete index comprises an index equal to the length of the desired patterned thin-film plus a buffer length.

37. The method of claim 29, wherein said step of positioning said fibrous substrate comprises rotating said fibrous substrate.

38. The method of claim 37, wherein said step of rotating said fibrous substrate comprises rotating said fibrous substrate about said axis of said substrate.

39. The method of claim 37, wherein said step of rotating said fibrous substrate comprises rotating said fibrous substrate about an axis parallel to said axis of said substrate.

40. The method of claim 37, wherein said step of rotating said fibrous substrate comprises rotating said fibrous substrate about an axis perpendicular to said axis of said substrate.

41. The method of claim 29, wherein said step of positioning said fibrous substrate comprises disposing said fibrous substrate in a non-contact position relative to said means for shadow masking.

42. The method of claim 29, wherein said step of positioning said fibrous substrate comprises linearly positioning said fibrous substrate.

43. The method of claim 29, wherein said step of positioning said fibrous substrate comprises incrementally positioning said fibrous substrate.

44. The method of claim 29, wherein said step of positioning said fibrous substrate comprises bi-directionally positioning said fibrous substrate.

45. The method of claim 44, wherein said step of bi-directionally positioning said fibrous substrate is accomplished by bi-directionally positioning said means for shadow masking.

46. The method of claim 45, wherein said step of bi-directionally positioning said means for shadow masking comprises positioning two or more means for shadow masking independently of one another.

47. The method of claim 1, wherein said means for shadow masking comprises a plurality of tubular members.

48. The method of claim 47, wherein a pair of said tubular members are separated by a distance.

49. The method of claim 48, wherein said distance defines the length of said patterned thin film.

50. The method of claim 48, wherein said distance defines the deposition area.

51. The method of claim 48, further comprising the step of positioning said members.

52. The method of claim 51, wherein said positioning said members comprises indexing said positioning of said members.

53. The method of claim 52, wherein said step of indexing comprises continuously indexing said positioning.

54. The method of claim 52, wherein said step of indexing comprises discretely indexing said positioning.

55. The method of claim 54, wherein said step of discretely indexing said positioning further comprises engaging a first indexing member and a second indexing member mechanically.

56. The method of claim 55, wherein said step of discretely indexing said positioning further comprises a plurality of indexed positions.

57. The method of claim 55, wherein said step of discretely indexing said positioning further comprises four indexed positions.

58. The method of claim 57, wherein a pair of consecutive positions of said four indexed positions comprise an interposition separation of approximately one-quarter inch.

59. The method of claim 55, further comprising connecting said first indexing member to said means for shadow masking.

60. The method of claim 54, wherein said step of discretely indexing said positioning comprises electronically indexing.

61. The method of claim 60, wherein said step of electronically indexing comprises storing an index in a computer readable medium.

62. The method of claim 60, wherein said step of electronically indexing comprises an index based on the position of a stepper motor.

63. The method of claim 60, wherein said step of electronically indexing further comprises comparing a measured position of said means of shadow masking to a desired position of said means of shadow masking.

64. The method of claim 51, further comprising remotely controlling said positioning of said members.

65. The method of claim 64, wherein said step of remotely controlling said positioning comprises controlling said positioning pneumatically.

66. The method of claim 64, wherein said step of remotely controlling said positioning comprises controlling said positioning using radio frequency controls.

67. The method of claim 64, wherein said step of remotely controlling said positioning comprises controlling said position using wired controls.

68. The method of claim 1, wherein said step of providing a means for shadow masking comprises providing a tubular member having a plurality of interior diameters.

69. The method of claim 1, wherein said step of positioning comprises providing tension in said fibrous substrate.

70. The method of claim 1, wherein said step of positioning comprises providing compression in said fibrous substrate.

71. The method of claim 1, further comprising
providing a deposition chamber, having an interior surface and an exterior surface, and
disposing at least a portion of said fibrous substrate within said deposition chamber.

72. The method of claim 71, further comprising controlling pressure within said deposition chamber.

73. The method of claim 71, wherein said step of providing said means for shadow masking comprises disposing at least a portion of said means for shadow masking within said deposition chamber.

74. The method of claim 71, wherein said step of providing said means for shadow masking comprises attaching said means for shadow masking to said interior surface.

75. The method of claim 71, wherein said means for shadow masking comprises said interior surface of said deposition chamber.

76. The method of claim 71, wherein said step of providing said deposition chamber comprises providing a plurality of engaged segments.

77. The method of claim 76, further comprising adapting a first engaged segment for engagement in a indexed position relative to a second engaged segment.

78. The method of claim 76, further comprising rotatably engaging a first engaged segment with a second engaged segment.

79. The method of claim 71, comprising providing a plurality of said deposition chambers and disposing at least a portion of said substrate in one or more said deposition chambers.

80. The method of claim 79, further comprising disposing a buffer chamber between a pair of deposition chambers.

81. The method of claim 1, further comprising patterning said thin film material according to a functional pattern.

82. The method of claim 81, wherein said functional pattern comprises a multilayer functional pattern.

83. The method of claim 81, wherein said functional pattern comprises a configuration selected from a group consisting of lithium battery configuration, buried lithium battery configuration, lithium-ion battery configuration, buried lithium-ion battery configuration, lithium-free battery configuration, buried lithium-free battery configuration, copper-indiumgallium-selenide photovoltaic cell configuration, and multilayer interconnect configuration.

84. The method of claim 1, wherein said step of depositing comprises a deposition technique selected from a group consisting of sputter plasma, electron beam evaporation processing, cathodic arc evaporation, chemical vapor evaporation, chemical vapor deposition, and plasma enhanced chemical vapor deposition.

85. The method of claim 1, further comprising a step of patterning said thin film material.

86. The method of claim 85, wherein said step of patterning comprises a patterning technique selected from a group consisting of laser ablation, chemical etching, mechanical etching, and photolithographic film masking.

87. The method of claim 1, further comprising a step of pre-sputtering prior to said step of depositing a thin film material.

88. An apparatus for depositing a patterned thin film on a fibrous substrate comprising:
means for shadow masking,
fibrous substrate having a length and a cross-section, disposed in a masked position relative to said means for shadow masking,
means for positioning said substrate, and
thin film material deposited on an area of said fibrous substrate.

89. The apparatus of claim 88, wherein said thin film material comprises a multi-layer thin film material.

90. The apparatus of claim 88, wherein said fibrous substrate comprises a substantially circular cross-section.

91. The apparatus of claim 90, wherein said cross-section is between approximately 1 micron and approximately one-quarter inch.

92. The apparatus of claim 88, wherein said fibrous substrate comprises an elliptical cross-section.

93. The apparatus of claim 92, wherein a diameter of said cross-section is between approximately 1 micron and approximately one-quarter inch.

94. The apparatus of claim 88, wherein said fibrous substrate comprises a substantially rectangular cross-section.

95. The apparatus of claim 94, wherein a side of said cross-section is between approximately 1 micron and approximately five inches.

96. The apparatus of claim 88, wherein said fibrous substrate comprises a ribbon-like substrate.

97. The apparatus of claim 88, wherein said fibrous substrate comprises a dynamic cross-section.

98. The apparatus of claim 97, wherein said dynamic cross section comprises variations along said length of said fibrous substrate.

99. The apparatus of claim 97, wherein said dynamic cross section comprises variations over time.

100. The apparatus of claim 88, wherein said fibrous substrate is rigid.

101. The apparatus of claim 88, wherein said fibrous substrate is flexible.

102. The apparatus of claim 88, wherein said fibrous substrate is suitable for use in weaving.

103. The apparatus of claim 88, wherein said fibrous substrate is deformable.

104. The apparatus of claim 88, wherein said fibrous substrate is elastic.

105. The apparatus of claim 88, wherein said fibrous substrate is windable.

106. The apparatus of claim 88, wherein said fibrous substrate comprises means for one or more functions selected from a group consisting of
thermal insulation,
thermal conduction,
electrical insulation,
electrical conduction,
charge storage,
magnetic field storage,
optical transmission,
shadowing,
data transmission,
data storage,
provision of structural rigidity,
provision of structural flexibility,
provision of static structural shape,
provision of dynamic structural shape,
provision of tensile strength,
provision of compressive strength,
electromagnetic energy absorption,
electromagnetic energy reflection,
liquid absorption,
liquid transmission,
liquid storage,
gas absorption,
gas transmission,
gas storage,
fuel absorption,
fuel transmission, and
fuel storage.

107. The apparatus of claim 88, wherein said fibrous substrate comprises copper.

108. The apparatus of claim 107, wherein said fibrous substrate comprises a diameter of approximately 100 microns.

109. The apparatus of claim 88, wherein said fibrous substrate comprises Iconel 600.

110. The apparatus of claim 109, wherein said fibrous substrate comprises a diameter of approximately 100 microns.

111. The apparatus of claim 88, wherein said fibrous substrate comprises an optical fiber.

112. The apparatus of claim 111, wherein said optical fiber comprises a diameter of approximately 100 microns.

113. The method of claim 1, wherein said fibrous substrate comprise a material selected from a group consisting of glass, ceramic, sapphire, polymer, metal, metal alloy, carbon, semiconductor, shape memory alloy, and polished naturally occurring fibers.

114. The method of claim 113, wherein said polished naturally occurring fibers comprise a material selected from a group consisting of wool, cotton, hemp, and wood.

115. The apparatus of claim 88, wherein said fibrous substrate comprises a length of between about one inch to about 4 feet.

116. The apparatus of claim 88, wherein said fibrous substrate comprises a length greater than four feet.

117. The apparatus of claim 116, wherein said fibrous substrate comprises a length greater than 100 feet.

118. The apparatus of claim 116, wherein said fibrous substrate comprises a length greater than 1000 feet.

119. The apparatus of claim 88, further comprising means for storing said fibrous substrate.

120. The apparatus of claim 119, wherein said means for storing said fibrous substrate comprises a means selected from the group consisting of
a spool,
a reel, and
a drum.

121. The apparatus of claim 119, wherein said means for positioning said substrate further comprise said means for storing said substrate.

122. The apparatus of claim 119, further comprising means for separating at least a pair of windings of said substrate about said means for storing said fibrous substrate.

123. The apparatus of claim 122, wherein said means for separating comprises a comb-like structure.

124. The apparatus of claim 88, wherein said means for positioning said fibrous substrate comprises means for positioning the substrate co-axially.

125. The apparatus of claim 124, wherein said means for positioning said fibrous substrate comprises means for preventing co-axial motion.

126. The apparatus of claim 124, wherein said means for positioning said fibrous substrate comprises means for providing tension in said substrate.

127. The apparatus of claim 124, wherein said means for positioning said fibrous substrate comprises means for providing compression in said substrate.

128. The apparatus of claim 124, wherein said means for positioning said fibrous substrate comprises means for moving said fibrous substrate co-axially.

129. The apparatus of claim 128, wherein said means for moving said fibrous substrate coaxially comprises a means for indexing said means for moving said fibrous substrate coaxially.

130. The apparatus of claim 129, wherein said means for indexing comprises a discrete index.

131. The apparatus of claim 130, wherein said discrete index comprises an index equal to the length of the desired patterned thin-film plus a buffer length.

132. The apparatus of claim 124, wherein said means for positioning said fibrous substrate comprises means for rotating said fibrous substrate.

133. The apparatus of claim 132, wherein said means for rotating said fibrous substrate comprises means for rotating said fibrous substrate about its axis.

134. The apparatus of claim 132, wherein said means for rotating said fibrous substrate comprises means for rotating said fibrous substrate about an axis parallel to its axis.

135. The apparatus of claim 132, wherein said means for rotating comprise a driven axial member, a pair of co-axial semi-members, and means for translating rotational motion from said axial member to said pair of co-axial semi-members.

136. The apparatus of claim 132, wherein said means for rotating said fibrous substrate comprises means for rotating said fibrous substrate about an axis perpendicular to its axis.

137. The apparatus of claim 124, wherein said means for positioning said fibrous substrate comprises a means for providing said fibrous substrate in a non-contact position relative to said means for shadow masking.

138. The apparatus of claim 124, wherein said means for positioning said fibrous substrate comprises linear means for positioning said fibrous substrate.

139. The apparatus of claim 124, wherein said means for positioning said fibrous substrate comprises incremental means for positioning said fibrous substrate.

140. The apparatus of claim 124, wherein said means for positioning said fibrous substrate comprises bi-directional means for positioning said fibrous substrate.

141. The apparatus of claim 140, wherein said means for positioning said fibrous substrate comprise means for bi-directionally positioning said means for shadow masking.

142. The apparatus of claim 141, wherein said means for bi-directionally positioning said means for shadow masking comprises means for moving two or more said means for shadow masking independently of one another.

143. The apparatus of claim 88, wherein said means for shadow masking comprises a tubular member having an interior diameter and an exterior diameter.

144. The apparatus of claim 143, wherein said tubular member further comprises a machined slot.

145. The apparatus of claim 144, wherein said machined slot comprises a single piece.

146. The apparatus of claim 144, wherein said machined slot comprises a plurality of pieces which may be removably engaged to define said slot.

147. The apparatus of claim 143, wherein said interior diameter comprises a shape selected from a group consisting of square, round, elliptical, and rectangular.

148. The apparatus of claim 147, wherein said interior diameter further comprises a conical counterbore.

149. The apparatus of claim 143, wherein said interior diameter comprises a diameter that is between about 0.001 inches and 0.100 inches greater than said cross-section of said fibrous substrate.

150. The apparatus of claim 143, wherein said interior diameter comprises a first dimension that is between about 0.001 inches and 0.100 inches greater than a first dimension of said cross-section of said fibrous substrate.

151. The apparatus of claim 150, wherein said interior diameter further comprises a second dimension that is between about 0.001 inches and 0.100 inches greater than the sum of the second dimensions of a plurality of said fibrous substrates.

152. The apparatus of claim 88, wherein said means for shadow masking comprises a plurality of tubular members.

153. The apparatus of claim 152, wherein a pair of said members are separated by a distance.

154. The apparatus of claim 153, wherein said distance defines the shape of said patterned thin film.

155. The apparatus of claim 153, wherein said distance defines the deposition area.

156. The apparatus of claim 153, further comprising means for positioning said members.

157. The apparatus of claim 156, wherein said means for positioning said members comprises means for indexing said positioning said members.

158. The apparatus of claim 157, wherein said means for indexing comprises a means for continuously indexing said positioning.

159. The apparatus of claim 157, wherein said means for indexing comprises a means for discretely indexing said positioning.

160. The apparatus of claim 159, wherein said means for discretely indexing said positioning comprises the mechanical engagement of a first indexing member and a second indexing member.

161. The apparatus of claim 160, wherein said means for discretely indexing said positioning further comprises a plurality of indexed positions.

162. The apparatus of claim 160, wherein said means for discretely indexing said positioning further comprises four indexed positions.

163. The apparatus of claim 162, wherein a pair of consecutive positions of said four indexed positions comprise an interposition separation of approximately one-quarter inch.

164. The apparatus of claim 160, wherein said first indexing member is connected to said means for shadow masking.

165. The apparatus of claim 159, wherein said means for discretely indexing said positioning comprises an electronic index.

166. The apparatus of claim 165, wherein said electronic index comprises an index stored in a computer readable medium.

167. The apparatus of claim 165, wherein said electronic index comprises an index based on the position of a stepper motor.

168. The apparatus of claim 165, wherein said electronic index further comprises a means of comparing a measured position of said means of shadow masking to a desired position of said means of shadow masking.

169. The apparatus of claim 156, further comprising means for remotely controlling said positioning said members.

170. The apparatus of claim 169, wherein said means for remotely controlling said positioning comprises pneumatic controls.

171. The apparatus of claim 169, wherein said means for remotely controlling said positioning comprises radio frequency controls.

172. The apparatus of claim 169, wherein said means for remotely controlling said positioning comprises wired controls.

173. The apparatus of claim 88, wherein said means for shadow masking comprises a tubular member having a plurality of interior diameters.

174. The apparatus of claim 88, wherein said means for positioning comprises means for providing tension in said fibrous substrate.

175. The apparatus of claim 88, wherein said means for positioning comprises means for providing compression in said fibrous substrate.

176. The apparatus of claim 88, further comprising a deposition chamber, having an interior surface and an exterior surface, within which interior surface at least a portion of said fibrous substrate is disposed.

177. The apparatus of claim 176, further comprising means for controlling pressure within said deposition chamber.

178. The apparatus of claim 176, wherein said means for shadow masking is disposed within said deposition chamber.

179. The apparatus of claim 176, wherein said means for shadow masking is attached to said interior surface.

180. The apparatus of claim 176, wherein said means for shadow masking comprises said interior surface of said deposition chamber.

181. The apparatus of claim 176, wherein said deposition chamber comprises a plurality of engaged segments.

182. The apparatus of claim 181, wherein a first engaged segment is adapted for engagement in a indexed position relative to a second engaged segment.

183. The apparatus of claim 181, wherein a first engaged segment is in rotatable engagement with a second engaged segment.

184. The apparatus of claim 176, comprising a plurality of said deposition chambers having at least a portion of said substrate disposed in one or more said deposition chambers.

185. The apparatus of claim 184, further comprising a buffer chamber disposed between a pair of deposition chambers.

186. The apparatus of claim 88, wherein said thin film material comprises a material selected from a group consisting of a metal, a metallic alloy, an intermetallic compound, an electronically conducting oxide, a semi-conducting oxide, an electronically conducting nitride, a semi-conducting nitride, an electronically conducting oxynitride, a semi-conducting oxynitride, an electronically conducting carbide, a semi-conducting carbide, electronically conducting partially sp2-hybridized carbon, semi-conducting partially sp2-hybridized carbon, III-V semi-conductor compounds, II-VI semi-conductor compounds, an electronically conducting organic polymeric compound, a semi-conducting organic polymeric compound, an electronically insulating oxide, an electronically insulating nitride, an electronically insulating oxynitride, an electronically insulating carbide, an electronically insulating partially sp3-hybridized carbon, an electronically insulating chalcogenide, an electronically insulating halide, and an electronically insulating organic polymeric compound.

187. The apparatus of claim 88, wherein said thin film material is arranged in a functional pattern.

188. The apparatus of claim 187, wherein said functional pattern comprises a multi-layer functional pattern.

189. The apparatus of claim 187, wherein said functional pattern is selected from a group consisting of lithium battery configuration, buried lithium battery configuration, lithium-ion battery configuration, buried lithium-ion battery configuration, lithium-free battery configuration, buried lithium-free battery configuration, copper-indium-gallium-selenide photovoltaic cell configuration, and multilayer interconnect configuration.

190. The apparatus of claim 88, wherein said depositing comprises depositing by means of a technique selected from a group consisting of sputter plasma, electron beam evaporation processing, cathodic arc evaporation, chemical vapor evaporation, chemical vapor deposition, and plasma enhanced chemical vapor deposition.

191. The apparatus of claim 88, further comprising means for performing additional patterning of said functional pattern.

192. The apparatus of claim 191, wherein said means for additional patterning comprise a technique selected from a group consisting of laser ablation, chemical etching, mechanical etching, and photolithographic film masking.
